(19) United States
(12) Patent Application Publication
(10) Pub. No.: US 2006/0176460 A1
(43) Pub. Date: Aug. 10, 2006

(54) Lithographic optical systems including exchangeable optical-element sets

(75) Inventors: Alton H. Phillips, East Palo Alto, CA (US); Douglas C. Watson, Campbell, CA (US)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 11/233,968

(22) Filed: Sep. 23, 2005

Related U.S. Application Data
(60) Provisional application No. 60/652,437, filed on Feb. 10, 2005.

(51) Int. Cl. G03B 27/54

(52) U.S. Cl. 355/67; 355/53

(57) ABSTRACT

Optical systems are disclosed for use in lithography systems, especially extreme-ultraviolet (EUV) lithography systems. An exemplary optical system includes at least a first optical-element set and a second optical-element set that are collectively configured to perform an optical function in which, for example, the first and second optical-element sets receive an EUV light flux from an EUV source and direct the EUV light flux to a pattern master so as to illuminate a selected region of the pattern master. At least one of the first and second optical-element sets is provided as an ensemble of multiple counterpart optical-element sets that are individually selectable for positioning and use at an operational position for performing the optical function. For each ensemble, a respective exchange mechanism holds the ensemble and moves a selected counterpart optical-element set of the ensemble from an off-line position for placement at the operational position and to move another counterpart optical-element set of the ensemble from the operational position to an off-line position.

### CROSS REFERENCE TO RELATED APPLICATION

This application claims priority from U.S. Provisional Application No. 60/652,437, filed Feb. 10, 2005, which is incorporated herein by reference in its entirety.

### FIELD

This disclosure pertains to, inter alia, microlithography, which is a key imaging technology used in the formation of circuit layers in semiconductor integrated circuits, displays, memory devices, and the like. More specifically, the disclosure pertains to microlithography systems employing, for imaging purposes, a wavelength of electromagnetic radiation that must propagate in a subatmospheric (“vacuum”) environment to avoid significant scattering and attenuation of the electromagnetic radiation. Even more specifically, the disclosure pertains to microlithography systems utilizing extreme ultraviolet (EUV) light (also termed “soft X-ray” light) for imaging purposes.

### BACKGROUND

Microlithography involves the “transfer” of a pattern, having extremely small features, from a pattern-defining object to an imprintable object. In “projection-microlithography” the pattern-defining object is usually termed a “reticle” or “mask,” and the imprintable object is termed a “substrate,” which usually is a semiconductor wafer that may or may not already have previously formed circuit layers on its surface. So as to be imprintable with an image, the substrate is coated with a radiation-sensitive composition termed a “resist.”

Projection-microlithography systems are used extensively, for example, for manufacturing integrated circuits, microprocessors, memory “chips,” and the like. These products characteristically comprise multiple functional layers of microscopic circuit elements, all interconnected together in 3-dimensional space. Typically, microlithography is used for patterning most, if not all, the functional layers. In each microlithographic step, the pattern-defining object (usually a mask or reticle) defines the respective pattern for the particular functional layer to be formed. A beam of exposure radiation, termed an “illumination beam,” is directed by an “illumination-optical system” from a source to the pattern-defining object. Interaction of the illumination beam with the pattern-defining object (i.e., selective transmission of the illumination beam through the pattern-defining object or selective reflection of the illumination beam from the pattern-defining object) results in patterning of the beam (now termed a “patterned beam” or “imaging beam”), which renders the patterned beam capable of forming an aerial image of the illuminated pattern. The patterned beam is projected by a “projection-optical system” onto a desired location on the resist-coated substrate where an actual image of the illuminated pattern is formed. Thus, a projection-microlithography system is a type of camera that projects and forms an image on the resist-coated substrate (analogous to a sheet of photographic paper) corresponding to the pattern defined by the pattern-defining object (analogous to a photographic negative, for example). For simplicity herein, the pattern-defining object is generally termed a “reticle.”

For exposure, the reticle usually is held on a device called a “reticle stage,” and the substrate usually is held on a device called a “substrate stage.” These stages also are typically equipped to perform highly accurate positional measurements and positioning in response to the measurements. Some microlithography systems have multiple reticle stages and/or multiple substrate stages which allow, for example, pre-exposure or post-exposure manipulations to be performed on other reticles and substrates, respectively, as an exposure is being performed on a particular substrate.

Before being exposed, and to prepare the substrate for exposure, the substrate is usually primed and then coated with a layer of a suitable resist. Before actual exposure, the resist usually is treated such as by a soft-bake step (“pre-exposure bake”). After exposure, the substrate may be soft-baked again (“post-exposure bake”), followed by development of the resist and a hard-bake step to prepare the resist for downstream process steps such as etching, doping, metallization, oxidation, or other suitable step in which the remaining resist on the substrate surface serves as a process mask. Thus, the respective layer is formed on the substrate. As noted above, multiple layers must be formed on the substrate in order to fabricate actual semiconductor devices, so these or similar process steps usually need to be repeated multiple times during the fabrication of the devices. During formation of each layer, steps must be taken to ensure proper and accurate registration of the new layer with the previously formed layer(s).

The substrate usually is sufficiently large to allow formation of multiple semiconductor devices at respective locations (“dies”) on the substrate. Exposure of multiple dies on the substrate can be die-to-die in one shot per die (characteristic of a “step-and-repeat” exposure scheme) or by scanning each die (characteristic of a “step-and-scan” exposure scheme). In step-and-scan each die typically is exposed by scanning in a scanning direction, wherein both the reticle and the substrate are moved during scanning. Movement of the reticle and substrate can be in the same direction or in opposite directions. If the projection-optical system has a magnification factor (M) other than unity, then the scanning velocity of the substrate typically is M times the scanning velocity of the reticle.

After completing the fabrication of all the required layers on the surface of the substrate, the dies are cut one from the other. Individual dies are mounted on a packaging substrate, connected to pins or the like, and encased to form finished semiconductor devices. The finished devices typically undergo rigorous testing before being released for sale.

Accompanying the acknowledgement of an apparent limit (not yet defined) of the minimum feature size of a pattern that can be transferred at an acceptable resolution by optical microlithography, a substantial ongoing effort currently is being directed to the development of a practical “next-generation lithography” (“NGL”) technology. One promising NGL approach is EUV lithography (“EUVL”) performed generally in the wavelength range of 5-20 nm and more specifically at a wavelength in the range of approximately 11-14 nm.

One challenge posed by EUVL is the substantial scattering and attenuation of an EUV beam by normal-pressure air. Consequently, the propagation path of an EUV beam in an EUVL system must be maintained at high vacuum. Another challenge posed by EUVL is the lack of any known material that is EUV-transmissive and capable of refracting EUV light. Consequently, all the optical elements in an EUV optical system must be reflective rather than refractive. These reflective optical systems and elements include the illumination-optical system, the projection-optical system, and the reticle itself.

The respective reflective elements making up the reticle, the illumination-optical system, and the projection-optical system of an EUVL system must be fabricated extremely accurately to obtain the level of optical performance currently being demanded. The elements also must perform their intended functions without exhibiting significant degradation of performance caused, for example, by repeated or prolonged exposure to the EUV radiation and/or by accumulation of dust, other debris, and/or contamination on the reflective surfaces of the elements.

Yet another challenge posed by EUVL is the source of the EUV light. A particularly suitable source is an EUV beam produced by a synchrotron, undulator, or analogous device. But, synchrotrons and undulators are very large, enormously expensive, and enormously complex devices, and very few facilities have access to a synchrotron. Other sources have been developed, including discharge-plasma and laser-plasma sources. Whereas these other sources are advantageously compact and relatively portable, they unfortunately produce substantial amounts of debris that tends to become deposited on the optical elements especially of the illumination-optical system. Consequently, current EUVL systems must be shut down frequently for optical-maintenance tasks such as mirror cleaning and/or replacement.

Certain aspects of a conventional EUVL system 800 are shown in FIG. 20. The depicted system 800 includes an EUV source 802, an illumination-optical system 804, and a projection-optical system 806. The EUV source 802 produces pulses of EUV light from, for example, a laser-induced plasma or electrical-discharge-induced plasma. Light from the plasma is reflected, within the source, from a concave collector mirror 808, which collects the light produced by the plasma and directs the collected light 810 to the illumination-optical system 804. The EUV source 802 typically includes a filter 812 that removes, from the EUV light produced by the plasma, extraneous and unwanted wavelengths of light (including visible light) as the EUV light 810 exits the source 802. Thus, the light 810 exiting the source 802 consists almost exclusively of the particular wavelength (e.g., 13.4 nm) of EUV light desired for making lithographic exposures.

The depicted illumination-optical system 804 includes a collimator mirror 814, a first fly-eye mirror 816, a second fly-eye mirror 818, a first condenser mirror 820, a second condenser mirror 822, and a grazing-incidence mirror 824. The mirrors 814, 816, 818, 820, 822 are mounted at respective locations on a rigid frame (not shown) so as to place the mirrors in proper respective positions relative to each other. The collimator mirror 814 collimates the EUV light 810 from the source 802 as the EUV light reflects from the collimator mirror. The collimated light 824 propagates to the first fly-eye mirror 816, from which the light 826 reflects to the second fly-eye mirror 818. The first fly-eye mirror 816 typically is arc-shaped (corresponding approximately to the illumination field), and the second fly-eye mirror 818 typically has a rectangular profile. The fly-eye mirrors 816, 818 make the illumination intensity of the EUV light substantially uniform over the illumination field. From the second fly-eye mirror 818 the EUV light 828 assumes a gradually convergent characteristic as the EUV light propagates to and reflects from the first and second condenser mirrors 820, 822. From the second condenser mirror 822 the EUV light 830 reflects (at grazing incidence) from the grazing-incidence mirror 824 (usually a planar mirror) to the reticle 832 where the illumination field illuminates respective selected portions of the reticle pattern at particular instances in time. During illumination, the reticle 832 is mounted (reflective-side facing downward) on a reticle chuck 834 that is mounted on a movable reticle stage 836. The reticle stage 836 positions the reticle 832 as required for illumination of the desired portions of the reticle pattern by the illumination field at respective instances in time.

The particular type of illumination-optical system 804 shown in FIG. 20 is a 6-mirror system. So as to be reflective to incident EUV light at less than grazing angles of incidence, the collimator mirror 814, fly-eye mirrors 816, 818, and condenser mirrors 820, 822 have surficial multilayer-interference coatings (e.g., multiple superposed and very thin layer pairs of Mo and Si) that render the surfaces of these mirrors reflective to incident EUV light. Due to the manner in which the EUV light reflects from the grazing-incidence mirror 824 (i.e., at grazing angles of incidence), the grazing-incidence mirror need not have a multilayer coating. In the EUV source 802, the collector mirror 808 also has a multilayer-interference coating.

The EUV light 838 from the grazing-incidence mirror 824 is incident on the reticle 832 at a small angle of incidence (approximately 5 degrees). So as to be reflective to EUV light at such a small angle of incidence, the reticle 832 also has a multilayer-interference coating as well as EUV-absorbent bodies that define, along with spaces between the bodies, the particular pattern on the reticle that is to be transferred to a substrate. Thus, as the EUV light reflects from the irradiated region of the reticle 832, the EUV light 840 acquires an aerial image of the pattern on the reticle and thus is rendered capable of imaging the illuminated pattern on the surface of the substrate 842. The substrate 842 is mounted on a movable substrate stage 846.

The illumination-optical system 804 must be under high vacuum during operation. Hence, the illumination-optical system 804 is contained in a respective vacuum chamber 848. Similarly, during operation the projection-optical system must be under high vacuum, and hence is contained in a respective vacuum chamber 850.

To form the image on the surface of the substrate 842, the “patterned” EUV light 840 reflected from the reticle 832 passes through the projection-optical system 844, which also contains multiple reflective mirrors. Depending upon its particular configuration, the projection-optical system 844 usually has two, four, or six mirrors (not detailed) each having a respective multilayer-interference coating.

As mentioned above, plasma-based EUV sources 802 tend to produce debris and other contamination that poses a substantial maintenance problem with respect to optical components located in the EUV source itself and in neighboring systems. Also, the plasma is very hot and the light produced by the plasma is very intense; this combination of elevated temperature and illumination intensity can deteriorate nearby surfaces. For example, in the EUV source 302, the collector mirror 808 is closest to the plasma and thus tends to experience a rapid rate of debris accumulation from the plasma as well as deterioration caused by high temperature and intense illumination. As a result, the collector mirror 808 tends to require frequent maintenance (e.g., cleaning) and/or replacement, both of which involve a substantial interruption in the operation of the EUVL system. Similarly, the mirrors 814, 816, 818, 820, 822 in the illumination-optical system 304 (especially the collimator mirror 814) also become contaminated during use, and the closer a mirror is to the plasma, generally the more rapid the rate of contamination. Debris accumulation and other contamination of EUV optical elements are substantial problems because these phenomena cause substantial reductions in reflectivity (and thus performance) of the elements. Unfortunately, whenever the time for a maintenance event arrives, the EUVL system 800 must be shut down, the vacuum must be vented, and the optical systems opened up to remove the element(s) requiring maintenance. After cleaning, repair, or replacement of the element(s), the optical system(s) must be reassembled and aligned, the optical systems closed and evacuated, and the system recalibrated to restore the system to normal operational status. These various maintenance-related tasks consume enormous amounts of time and thus impose substantial detriments to system throughput, which can cause intolerable reductions in profitability of the semiconductor-fabrication facility in which the EUVL equipment is located. At the same time, these maintenance tasks must be performed quickly, without contaminating the system and without harming other parts of the system.

In addition, it currently is desirable that the EUVL system 800 have sufficient flexibility so as to be useful under various conditions and situations. For example, it currently is desirable that the system provide variable sigma (a) and/or field-size settings. As used herein, sigma is the “partial coherence parameter,” which is the ratio of the numerical aperture of the illumination system to the numerical aperture of the projection system. The numerical aperture of the illumination system conventionally is adjusted by exchanging apertures in the illumination system. (See U.S. Pat. No. 6,771,350.) But, use of these apertures reduces overall light intensity, which correspondingly reduces the overall productivity of the lithography tool. Furthermore, in a conventional EUVL system, imparting these changes typically requires shut-down of the system, as summarized above, to allow exchange of apertures and/or one or more optical elements that establish the respective parameters (e.g., sigma or size and shape of the illumination field).

### SUMMARY

The shortcomings of conventional apparatus and methods as summarized above are cured by apparatus and methods as disclosed herein. Certain of the various 20 embodiments disclosed herein provide at least one mirror (e.g., the collimator mirror) or mirror set (e.g., the fly-eye set, the condenser set, the fly-eye/collimator set, or the fly-eye/condenser set) that is selectable from multiple such mirrors or sets that are provided on an exchanger mechanism. The mirrors or sets are provided in respective “frames” or “modules” that can be manipulated, moved, and positioned without human handling of the constituent mirrors. Other sets of mirrors (e.g., fly-eye set, condenser set) that are not exchanged or exchangeable can be housed in respective frames or modules. The exchangers generally are configured to occupy minimal space. The exchanger mechanism desirably includes a non-contacting interface between the frame placed in the operational position and the adjacent frame, which allows frame exchange with minimal disturbance to non-exchanged optical elements and shortens the required time for any alignment performed after exchange. Also, exchanges can be performed with less particle generation, which minimizes contamination of the illumination-optical system and other systems with which the illumination-optical system is used. The actuators used for moving frames into position, as well as sensors used for detecting proper positioning of just-moved frames at their respective operational positions, serve to position and stabilize the frames and mirrors relative to a reference frame such as the projection-optics box (POB). In addition, the exchangers desirably are situated, with respect to any surrounding structure such as a vacuum chamber, so as to allow accessibility to the exchangers for service.

According to a first aspect of the disclosure, optical systems for lithography systems are provided. An embodiment of such an optical system comprises at least a first optical-element set and a second optical-element set collectively configured to perform an optical function in which the at least first and second optical-element sets receive a light flux from a light source and direct the light flux for lithographic-imaging purposes. At least one of the optical-element sets is provided in the optical system as an ensemble of multiple counterpart optical-element sets that are individually selectable for positioning and use in performing the optical function. For each ensemble, a respective storage-and-exchange mechanism is situated and configured to hold the ensemble and to move a selected optical-element set of the ensemble from an off-line position for placement at the operational position and to move another counterpart optical-element set of the ensemble from the operational position to an off-line position. By way of example, the lithography system is an EUV lithography system, wherein the optical system is an illumination-optical system in which each optical-element set comprises at least one respective EUV-reflective mirror.

In an embodiment of an optical system the first optical-element set can comprise the ensemble, and the second optical-element set can be stationary. Each counterpart optical-element set of the ensemble can comprise a respective collimator-mirror set, wherein the second optical-element set can comprise a fly-eye-mirror set and a condenser-mirror set. Alternatively, each counterpart optical-element set of the ensemble can comprise a collimator-mirror set and a fly-eye-mirror set, wherein the second optical-element set can comprise a condenser-mirror set.

In another embodiment of an optical system the first optical-element set can comprise a first ensemble, wherein the second optical-element set can comprise a second ensemble. Each counterpart optical-element set of the first ensemble can comprise a respective collimator-mirror set, and each counterpart optical-element set of the second ensemble can comprise a respective fly-eye-mirror set and a respective condenser-mirror set.

Another embodiment of the optical system further comprises a third optical-element set, wherein the first optical-element set comprises the ensemble, and the second and third optical-element sets are stationary. In such a system each counterpart optical-element set of the ensemble can comprise a respective collimator-mirror set, the second optical-element set can comprise a fly-eye-mirror set, and the third optical-element set can comprise a condenser-mirror set. Alternatively, each counterpart optical-element set of the ensemble can comprise a respective fly-eye-mirror set, the second optical-element set can comprise a collimator-mirror set, and the third optical-element set can comprise a condenser-mirror set.

Yet another embodiment of an optical system further can comprise a third optical-element set. In such a system the first optical-element set can comprise a first ensemble, the second optical-element set can comprise a second ensemble, and the third optical-element set can be stationary. In this system each counterpart optical-element set of the first ensemble can comprise a respective collimator-mirror set, each counterpart optical-element set of the second ensemble can comprise a respective fly-eye-mirror set, and the third optical-element set can comprise a condenser-mirror set. Alternatively, the first optical-element set can comprise a first ensemble, the second optical-element set can comprise a second ensemble, and the third optical-element set can comprise a third ensemble. In this system each counterpart optical-element set of the first ensemble can comprise a respective collimator-mirror set, each counterpart optical-element set of the second ensemble can comprise a respective fly-eye-mirror set, and each counterpart optical-element set of the third ensemble can comprise a respective condenser-mirror set.

According to another aspect, illumination-optical systems are provided for EUV lithography systems. An embodiment of such an illumination-optical system comprises at least a first mirror set and a second mirror set collectively configured to perform an optical function in which the first and second mirror sets receive an EUV light flux from an EUV source and direct the EUV light flux to a pattern master so as to illuminate a selected region of the pattern master. At least one of the first and second mirror sets is provided in the illumination-optical system as an ensemble of multiple counterpart mirror sets that are individually selectable for positioning and use at an operational position for performing the optical function. For each ensemble, a respective exchange mechanism is situated and configured to hold the ensemble and to move a selected counterpart mirror set of the ensemble from an off-line position for placement at the operational position and to move another counterpart mirror set of the ensemble from the operational position to an off-line position. In this system the first mirror set can be located closer to the EUV source, the second mirror set can be located more distantly from the EUV source than the first mirror set, and the ensemble can be of multiple selectable counterpart mirror sets of the first mirror set. The exchange mechanism can comprise a housing configured to hold the ensemble, wherein the housing can define, for example, a respective branch for each of the selectable counterpart mirror sets of the ensemble. In this configuration the exchange mechanism can be configured to move the respective branch of the selected counterpart mirror set into the operational position. The branches of the housing can be arranged as a turret that is rotatable about an axis by the exchange mechanism to place a selected branch of the turret in the operational position. The respective counterpart mirror set in each branch of the turret can comprise, for example, a respective collimator mirror.

In an illumination-optical system as summarized above, the first mirror set can comprise a mirror situated closest to the EUV source of all the mirrors of the illumination-optical system. In such a configuration the ensemble can be of multiple selectable counterpart mirror sets of the first mirror set.

If the first mirror set is a collimator-mirror set, then the second mirror set can comprise at least one fly-eye mirror and at least one condenser mirror, wherein the ensemble is of multiple selectable counterpart mirror sets of the first mirror set.

Each counterpart mirror set in the ensemble can consist of a single respective mirror. By way of example, each single respective mirror in the ensemble can be a respective collimator mirror. By way of another example, each single respective mirror in the ensemble can have identical optical properties. By way of another example, at least two of the single respective mirrors in the ensemble can have different optical properties. By way of yet another example, each counterpart mirror set in the ensemble can consist of multiple respective mirrors including a respective collimator mirror.

In another embodiment of an optical system the first mirror set is provided in the illumination-optical system as a first ensemble of multiple selectable counterpart mirror sets that are individually selectable for positioning and use in performing the optical function, and the second mirror set is provided in the illumination-optical system as a second ensemble of multiple selectable counterpart mirror sets that are individually selectable for positioning and use in performing the optical function. In this embodiment the first mirror set can be contained in a respective housing that holds the multiple selectable counterpart mirror sets of the first mirror set in respective branches of the housing, and the multiple selectable counterpart mirror sets of the second mirror set can be contained in individual respective housings. The respective exchange mechanism for the first mirror set moves a selected branch to a respective operational position, and the respective exchange mechanism for the second mirror set moves a selected counterpart mirror set in its respective housing to a respective operational position. The housing for the first mirror set can be configured so as not to contact the selected housing of the second mirror set. The system further can comprise a tracking interface situated between the respective operational position of the first mirror set and the respective operational position of the second mirror set. A respective actuator mechanism can be associated with at least one of the first and second mirror sets and configured to align the respective mirror set based on data, regarding positions of the selected counterpart mirror sets at their respective operational positions, produced by the tracking interface. The tracking interface can be configured to produce the position data in the absence of physical contact of the first mirror set with the second mirror set. The tracking interface can be configured to track, in an active manner, the position of one of the first and second mirror sets relative to the position of the other of the first and second mirror sets.

In another embodiment of an optical system each of the counterpart mirror sets of the first mirror set can comprise a respective collimator mirror, and each of the counterpart mirror sets of the second mirror set can comprise at least one mirror selected from the group consisting of fly-eye mirrors and condenser mirrors. For example, each of the counterpart mirror sets of the second mirror set can comprise a respective pair of fly-eye mirrors, and each of the counterpart mirror sets of the second mirror set further can comprise a respective pair of condenser mirrors.

Each of the counterpart mirror sets in the first mirror set can have identical optical properties, wherein at least two of the counterpart mirror sets in the second mirror set have different optical properties.

In another embodiment of an optical system at least two of the counterpart mirror sets in the first mirror set have different optical properties, and at least two of the counterpart mirror sets in the second mirror set have different optical properties. Alternatively, each of the counterpart mirror sets in the second mirror set has identical optical properties.

In another embodiment of an optical system each counterpart mirror set of the ensemble is housed in a respective housing, wherein the exchange mechanism can be operable to store the housings of off-line counterpart mirror sets and to move the housing of the selected counterpart mirror set into the operational position. By way of example, the exchange mechanism can comprise a rotary portion situated and configured to store the housings of off-line counterpart mirror sets, and the exchange mechanism can comprise a robot situated and configured to move the selected counterpart mirror set from the rotary portion to the operational position.

In another embodiment the first mirror set is provided in the illumination-optical system as a first ensemble of multiple selectable counterpart mirror sets that are individually selectable for positioning and use in performing the optical function. The second mirror set can be provided in the illumination-optical system as a second ensemble of multiple selectable counterpart mirror sets that are individually selectable for positioning and use in performing the optical function. Each counterpart mirror set of the first mirror set can comprise a respective collimator mirror, and each counterpart mirror set of the second mirror set can comprise a respective pair of fly-eye mirrors. Each counterpart mirror set of the second mirror set further can comprise a respective pair of condenser mirrors.

Another embodiment of an optical system can include a tracking interface situated between the first mirror set and the second mirror set. An exemplary tracking interface includes a position-sensing device that detects position of the first and second mirror sets relative to each other. This embodiment further can comprise at least one actuator system situated with at least one of the first and second mirror sets. The at least one actuator system can be selectively actuatable to perform an adjustment of the position of at least one of the first and second mirror sets relative to each other, based on data from the position-sensing device, to align the first and second mirror sets. The actuator system can comprise one or more actuators sufficient to move the respective mirror set in multiple degrees of freedom relative to the other mirror set.

According to another aspect, optical systems for an EUV lithography system are provided. An embodiment of such an optical system comprises first reflective-optical-element means and second reflective-optical-element means that are collectively configured to perform an optical function in which the first and second reflective-optical-element means receive EUV light from an EUV-source means and direct the EUV light for performing lithographic imaging. At least one of the reflective-optical-element means comprises an ensemble of multiple selectable counterpart reflective-optical-element sets that are individually selectable for positioning and use in performing the optical function. The optical system embodiment also includes exchange means, associated with each ensemble, for holding the ensemble, for moving a selected reflective-optical-element set of the ensemble from an off-line position for placement at the operational position, and for moving another counterpart reflective-optical-element set of the ensemble from the operational position to an off-line position.

In the optical system summarized above the optical system can comprise illumination-system means for illuminating a pattern-master means. In this configuration the optical function can comprise illuminating selected portions of the pattern-master means with the EUV light. At least the first reflective-optical-element means can comprise a respective ensemble and has an associated exchange means. In this configuration the first reflective-optical-element means can be situated proximally the EUV-source means to receive the EUV light from the EUV-source means. The first reflective-optical-element means can comprise at least collimating means for receiving the EUV light from the EUV-source means and collimating the EUV light as the EUV light reflects from said collimating means.

In another embodiment of the optical system both the first and second reflective-optical-element means can comprise a respective ensemble and an associated exchange means.

Another aspect is directed to methods set forth in the context of a lithography system. The subject methods are for maintaining on-line operation of an optical system of the lithography system. The optical system includes at least a first optical-element set and a second optical-element set that collectively perform an optical function in which the first and second optical-element sets receive a light flux from a light source and direct the light flux for a lithographic-imaging purpose. An embodiment of the method comprises configuring at least the first optical-element set as a respective ensemble of multiple counterpart optical-element sets that are individually selectable for positioning for use in performing the optical function. A desired counterpart optical-element set of the ensemble is selected. The desired counterpart optical-element set is placed at an operational position at which the selected counterpart optical-element set works cooperatively with the second optical-element set to perform the optical function. A currently selected counterpart optical-element set can be moved into the operational position upon removing a previously selected counterpart optical-element set from the operational position. The currently selected and previously selected counterpart optical-element sets can be moved using a storage-and-exchange robot.

In the methods, if the first optical-element set is vulnerable to contamination during use, then a currently selected counterpart optical-element set can be moved into the operational position to replace a previously selected counterpart optical-element set that has become contaminated. For example, if the microlithography system is an EUV lithography system, and if the optical system is situated downstream of an EUV source that produces particulate contamination, then the first optical-element set can be situated closer to the EUV source than the second optical-element set.

The first optical-element set can have a parameter that, when changed, correspondingly changes an operational aspect of the optical system. In this situation a currently selected counterpart optical-element set, having a first value of the parameter, can be moved into the operational position to replace a previously selected counterpart optical-element set having a second value of the parameter, wherein the first value of the parameter is more desired than the second value in performing the optical function.

In the methods summarized above, if the microlithography system is an EUV lithography system and the optical system is an illumination-optical system, the first optical system can comprise a collimator mirror. Alternatively, the first optical system can comprise at least one mirror selected from the group consisting of collimator mirrors, fly-eye mirrors, and condenser mirrors.

In another embodiment of the subject methods, the second optical-element set is configured as a respective ensemble of multiple counterpart optical-element sets that are individually selectable for positioning for use in performing the optical function. The methods include selecting a desired counterpart optical-element set of the respective ensemble of the second optical-element set and placing the desired counterpart optical-element set at a respective operational position at which the selected counterpart optical-element set works cooperatively with the selected counterpart optical-element set of the first optical-element set to perform the optical function. By way of example, the microlithography system can be an EUV lithography system, in which the optical system is an illumination-optical system situated downstream of an EUV source, the first optical-element set is closer to the EUV source than the second optical-element set, and the first optical-element set comprises at least a collimator mirror. In this example the second optical-element set can comprise at least one mirror selected from the group consisting of fly-eye mirrors and condenser mirrors.

Another embodiment of the methods further comprises actively tracking the first and second optical-element sets relative to each other, without contacting each other, to maintain alignment of the first and second optical-element sets with each other for performing the optical function.

Thus, using systems and methods as disclosed herein, it is possible, for example, to change the numerical aperture of an optical system without sacrificing productivity of the lithography system. Similarly, to maximize productivity for various field sizes, a portion of the illumination system can be exchanged so that illumination light is not wasted. (For EUV lithography, various field sizes include 26×31 mm, currently the maximum standard field size, and 25×25 mm.)

The foregoing and additional features and advantages of apparatus and methods as disclosed herein will be apparent from the following detailed description, which proceeds with reference to the accompanying drawings.

### BRIEF DESCRIPTION OF THE DRAWINGS

FIG. 1 is a schematic diagram of an exemplary illumination-optical system for an EUV microlithography system, illustrating certain relationships of the components with one another.

FIG. 2 is a schematic diagram of certain consequences of changing sigma (a;) of the illumination-optical system of FIG. 1 from 0.3 to 0.8.

FIG. 3 is a perspective view of an illumination-optical system according to a first representative embodiment that comprises a rotary exchanger holding multiple collimator (COL) frames each comprising a respective collimator mirror that can be selected, by rotation of the exchanger, for use in the illumination-optical system.

FIG. 4 is a schematic diagram showing control relationships of the first representative embodiment, in which the collimator (COL) frame and fly-eye/condenser (FE/CON) frame are independently mounted to the system base by respective mountings providing respective six degrees of freedom of adjustability as well as active vibration isolation and attenuation.

FIG. 5 is a schematic diagram showing control relationships of an alternative configuration of the first representative embodiment, in which the COL frame and FE/CON frame are mounted to an illumination-unit main frame that is mounted to the system base by a mounting providing six degrees of freedom of adjustability as well as active vibration isolation and attenuation.

FIG. 6 is a perspective view of an illumination-optical system according to a second representative embodiment that comprises a first rotary exchanger holding multiple COL frames, a second rotary exchanger holding multiple fly-eye (FE) frames, and a linear robot for selecting a FE frame and moving the selected FE frame to an operational position relative to the selected COL frame and the condenser (CON) frame.

FIG. 7 is a schematic diagram showing control relationships of the second representative embodiment, in which the collimator (COL) frame, the FE frame, and the CON frame are independently mounted to the system base by respective mountings providing respective six degrees of freedom of adjustability as well as active vibration isolation and attenuation.

FIG. 8 includes two perspective views of the illumination-optical system of the second representative embodiment contained in a housing.

FIG. 9 is a perspective view of an illumination-optical system according to the third representative embodiment that comprises multiple fly-eye/collimator (FEC) frames and a rotary exchanger for holding the FEC frames, wherein a selected FEC frame is moved into an operation position from the rotary exchanger.

FIG. 10 includes two perspective views of the illumination-optical system of the third representative embodiment, including a housing and vacuum pumps.

FIG. 11 provides a perspective view and several orthogonal views of an illumination-optical system according to a fourth representative embodiment, in which a selected one of multiple fly-eye/collector (FEC) frames can be placed in an operational position.

FIG. 12 is a perspective view of an illumination-optical system according to the fifth representative embodiment, in which a selected one of multiple FEC frames can be placed in an operational position.

FIG. 13 is a perspective view of an illumination-optical system according to the sixth representative embodiment, in which a selected one of multiple FEC frames can be placed in an operational position.

FIG. 14 is a perspective view of an illumination-optical system according to the seventh representative embodiment, in which one of multiple FEC frames (selected from a linear array of FEC frames) can be placed in an operational position.

FIG. 15 is a perspective view of an illumination-optical system according to the eighth representative embodiment, in which one of multiple FEC frames (selected from the FEC frames on a rotary exchanger) can be placed in an operational position.

FIG. 16 is a perspective view of an illumination-optical system according to the ninth representative embodiment, in which one of multiple fly-eye (FE) frames (selected from multiple such frames on a rotary exchanger) can be placed in an operational position.

FIG. 17 is a perspective view of an alternative configuration of the ninth representative embodiment, in which one of multiple FE frames (in a linear array) can be selected and placed in an operational position.

FIG. 18 is a block diagram of an exemplary semiconductor-device fabrication process that includes wafer-processing steps comprising a microlithography step performed using a microlithography system as described herein.

FIG. 19 is a block diagram of a wafer-processing process as referred to in FIG. 18.

FIG. 20 is a schematic diagram of certain optical components of a conventional EUVL system.

### DETAILED DESCRIPTION

This disclosure is set forth in the context of representative embodiments that are not intended to be limiting in any way.

General Considerations:

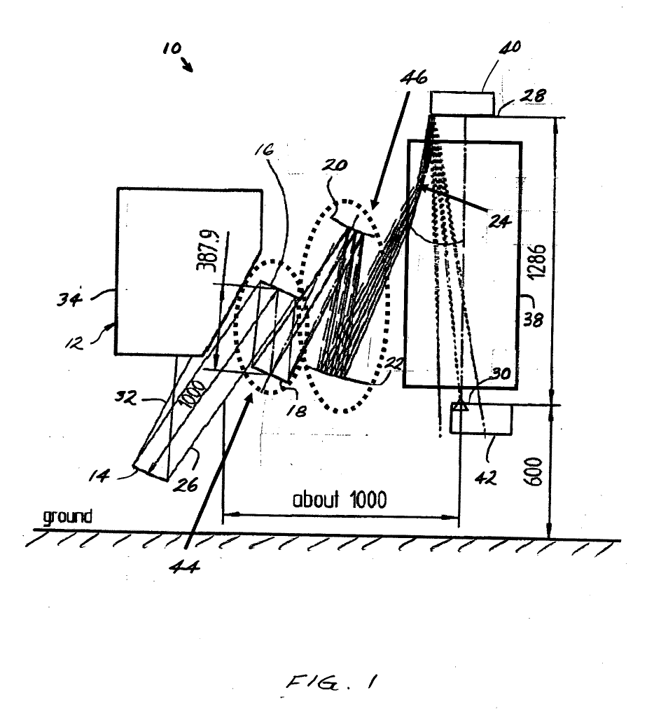

A layout of an exemplary illumination-optical system, with EUV source, is shown in FIG. 1. The system 10 is depicted with certain approximate dimensions, in mm. The system 10 includes an EUV source 12, a collimator mirror 14, a first fly-eye mirror 16, a second fly-eye mirror 18, a first condenser mirror 20, a second condenser mirror 22; and a planar grazing-incidence mirror 24. Also depicted are representative ray traces 26 from the collimator mirror 14 to the reticle 28. The wafer (substrate) 30 is situated optically downstream from the reticle 28.

The EUV source 12 includes the following features that are not detailed but are well-understood: a plasma zone where a target material is converted into a plasma (e.g., by intense laser illumination or electrical discharge), a collector mirror (for collecting EUV radiation radiating from the plasma zone and reflecting the collected EUV radiation in a desired direction as indicated by the trace 32), and a spectral filter (through which the beam of collected EUV radiation passes, to remove unwanted wavelengths of light) as the beam exits the EUV source 12. These components are contained in a housing 34 in which the atmosphere can be evacuated to a desired level.

Exemplary dimensions of the respective mirrors are as follows: collimator 14: 200 mm diameter; fly-eye mirrors 16, 18: each 200 mm diameter; first condenser 20: 100 mm diameter; and second condenser 22: 325 mm×150 mm. Exemplary heat loads (due principally to radiative heating from the incident EUV radiation) on the mirrors range from 80 W (for the collimator 14) to about 6 W (for the second condenser 22) if the spectral filter in the EUV source 12 is not used, and range from 40 W for the collimator 14) to about 3 W (for the second condenser 22) if the spectral filter in the EUV source is used. In either event, the greatest heat load is experienced by the collimator mirror 14 (because it is nearest the EUV source 12), and the least heat load is experienced by the grazing-incidence mirror 24. Conventionally, the collimator mirror 14, the fly-eye mirrors 16, 18, and the condenser mirrors 20, 22 are mounted on a rigid frame that is situated relative to the EUV source 12, grazing-incidence mirror 24, and reticle 28 and housed in a chamber in which the atmosphere can be evacuated to a desired level (<1 mTorr or <6.66 Pa).

FIG. 1 also depicts an outline of a projection-optics “box” 38 containing a projection-optical system 36. Because of the opposing positions of the reticle 28 and wafer 30, the projection-optical system 36 desirably comprises an even number of mirrors, such as two, four, or six mirrors (not detailed but understood in the art). The projection-optics box 38 desirably includes a reticle stage 40 (on which the reticle 28 is mounted by chucking, facing downward in the figure) and a wafer stage 42 (on which the wafer 30 is mounted by chucking, facing upward in the figure). The grazing-incidence mirror 24 for convenience is situated within the housing 38.

The two fly-eye mirrors 16, 18 can be regarded as a fly-eye (FE) “set” 44. Similarly, the two condenser mirrors 20, 22 can be regarded as a condenser (CON) “set” 46.

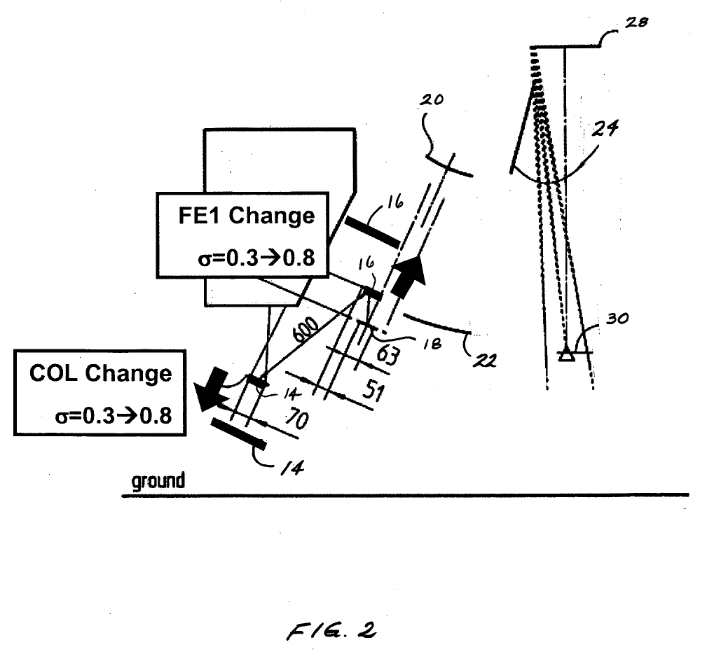

As noted above, it is desirable that the illumination-optical system 10 provide variable sigma (variable σ, wherein σ=NAᵢₗₗᵤₘ/NAₚᵣₒⱼ, and NAᵢₗₗᵤₘ is numerical aperture of the illumination-optical system and NAₚᵣₒⱼ is numerical aperture of the projection-optical system), for example three different a settings within a range of 0.3 to 0.8. (Variable sigma is useful for enhancing imaging quality for various types of pattern geometrics.) As shown in FIG. 2, changing (y from 0.3 to 0.8 involves a change in position and diameter of at least two mirrors, namely the collimator mirror (“COL”) 14 and the first fly-eye mirror (“FE1”) 16, and a change in diameter also of the second fly-eye mirror 18. As a result, in this example, the collimator mirror 14 and the first fly-eye mirror change position by as much as 200 mm, and the collimator mirror 14 and first and second fly-eye mirrors change diameter by as much as 150 mm. These dimensions represent substantial changes to the illumination-optical system 10. It also is desirable that the illumination-optical system 10 provide at least two different field settings. Providing the illumination-optical system 10 with two different field settings and three different a settings requires six different sets of fly-eye mirrors (each set having different sizes and/or positions of the two fly-eye mirrors 16, 18), and three different collimator mirrors 14 (each having a different size and/or position).

Each of the mirrors in the illumination-optical system desirably has very high stability. Exemplary stability specifications include:
Shape: ˜100 μm
Position: ˜20 μm
Tilt: ˜35 μrad
   In achieving the foregoing performance criteria, exemplary adjustment-resolution specifications are:
Position: 20 μm
Tilt: 15 grad (30 μm at 200 mm diameter)

To provide the foregoing features while meeting the stated specifications, various representative embodiments are set forth below that provide one or more “exchangers” allowing rapid exchange of a subject mirror or mirror set to meet the demands imposed by one or more of the following: (a) replacement of one or more excessively contaminated mirrors with clean or new mirrors; (b) exchanging one or more mirrors configured and positioned to meet a first optical setting with corresponding mirrors configured and positioned to meet a second optical setting.

### First Representative Embodiment

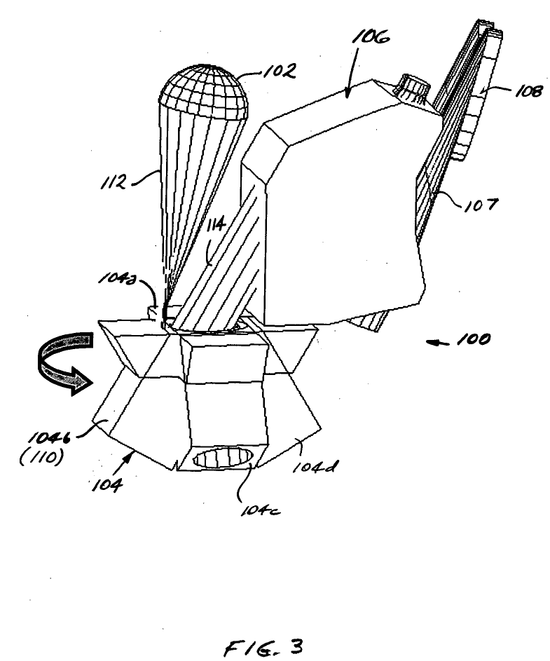

This embodiment, depicted in FIG. 3, provides an illumination-optical system 100 in which the collimator mirror can be exchanged. The embodiment of FIG. 3 depicts the following components: the collector mirror 102 of the EUV source (the remainder of the EUV source is not shown, but see FIG. 1), a four-way exchanger (turret) 104 housing and ensemble of four individually selectable collimator mirrors, a housing 106 containing a set of first and second fly-eye mirrors and a set of first and second condenser mirrors (see FIG. 1), and a grazing-incidence mirror 108. The exchanger 104 includes and/or serves as a “frame” and housing for the collimator mirrors, and hence also is termed a “COL frame.” Similarly, the housing 106 includes and/or serves as a “frame” for the mirrors inside it, and hence also is termed an “FE/CON frame.”

The COL frame 104 includes four independently selectable branches 104a-104d each containing a respective collimator mirror. The COL frame 104 is rotatable about an axis A1 to position a selected branch 104a-104d relative to the FE/CON frame 106. The respective collimator mirrors in the branches 104a-104d can be the same or different. For example, the branches 104a-104d can provide four different respective collimator mirrors each having a different size, a different surface profile, and/or a different position to provide four different respective optical settings. Alternatively, two or more of the collimator mirrors can be identical, in which configuration the COL frame 104 allows exchange of a contaminated collimator mirror for a clean or new one by simply rotating the turret to a different branch containing the clean or new mirror. Note that, in this embodiment, only one selected branch 104b can be in an operational position 110 at which the respective mirror can receive EUV light 112 from the collector mirror 102. EUV light 114 reflected from the collimator mirror in the selected branch 104b exits the COL frame 104 and enters the FE/CON frame 106 as the light propagates to the first fly-eye mirror situated in the FE/CON frame 106. In the FE/CON frame 106, the EUV light reflects, in succession, from the first fly-eye mirror, the second fly-eye mirror, the first condenser mirror, and the second condenser mirror. EUV light 107 reflected from the second condenser mirror exits the FE/CON frame 106 as the light propagates to the grazing-incidence mirror 108.

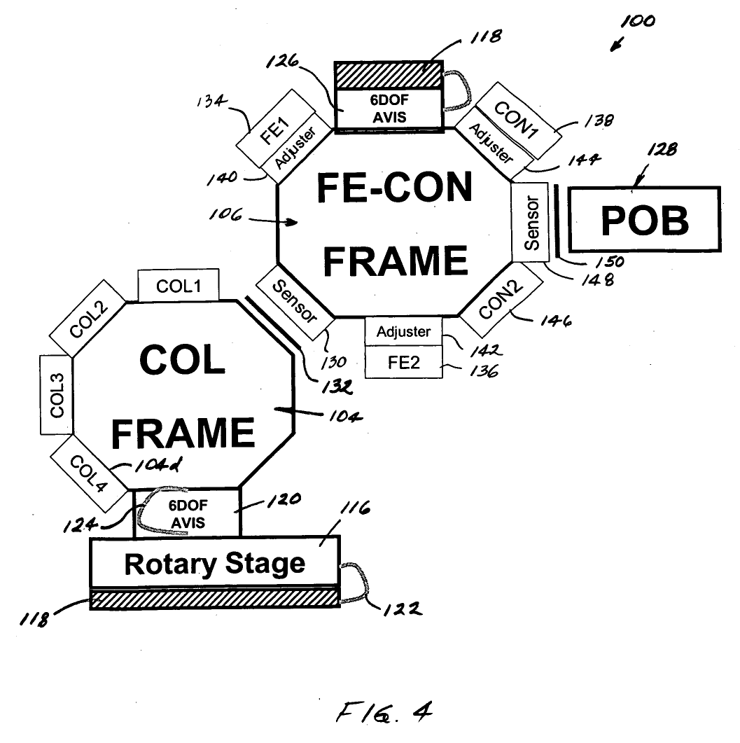

Desirably, the COL frame 104 does not physically contact the FE/CON frame 106, either during rotation of the COL frame or during use of the selected branch thereof. Turning now to FIG. 4, the COL frame 104 is mounted on a rotary stage 116 mounted to a system base 118. The rotary stage 116 is rotatable relative to the base 118 to rotate the COL frame 104 relative to the base 118 as required to select a particular branch 104a-104d. Between the stage 116 and the COL frame 104 is a mounting 120 providing an active vibration-isolation system (AVIS) and six degrees of freedom (6 DOF) of actuation motion (x, y, z, θₓ, θ_{y}, θ_{z}) of the COL frame (for positional-adjustment and vibration-isolation purposes) relative to the stage 116. Thus, the mounting 120 serves as a “fine stage” for the rotary stage 116, wherein the rotary stage 116 includes and serves as a coarse stage (not detailed). In FIG. 4 the branch 104d containing “collimator 4” (“COL4”) has been selected for use. Thus, the 6DOF mounting 120 imparts active vibration isolation and 6 DOF of positional adjustability of the branch 104d, and hence of the collimator mirror COL4. Since the 6DOF mounting 120 serves the entire COL frame 104, individual 6DOF mountings are not required for each collimator mirror COL1-COL4. This alleviates system complexity and simplifies routing of flexible hoses (for hydraulics) and electrical cables 122 extending between the base 118 and the rotary stage 116 and of hoses and cables 124 extending between the rotary stage 116 and the collimator mirrors COL1-COL4 in the COL frame 104. (Hoses and cables can introduce vibrations and moments to movable objects to which the hoses and cables are connected, so reducing the number of cables and hoses is advantageous.)

The FE/CON frame 106 is mounted to the base 118 via a mounting 126 providing an active vibration-isolation system (AVIS) and six degrees of freedom (6DOF) of actuation motion (x, y, z, θₓ, θ_{y}, θ_{z}) of the FE/CON frame 106 (for positional-adjustment and vibration-isolation purposes) relative to the system base 118 and relative to the projection-optics box (“POB”) 128. Determinations of the positions of the FE/CON frame 106 and COL frame 104 relative to each other are made by an appropriate sensor 130 across a tracking interface 132. The sensor 130 provides feedback to the 6DOF mounting 120. Thus, the COL frame 104 actively tracks the position of the FE/CON frame 106 using the 6DOF mounting 120. The sensor 130, served by a flexible cable (not shown) desirably is mounted to the FE/CON frame 106 rather than the COL frame 104 because the FE/CON frame 106 is stationary, which eliminates problems otherwise associated with attaching a cable to a movable object such as the COL frame 104.

For alignment purposes, at least the first fly-eye mirror (FE1) 134, the second fly-eye mirror (FE2) 136, and first condenser mirror (CON1) 138 include respective adjusters 140, 142, 144 for adjusting the position of the respective mirror relative to each other and to the FE/CON frame 106. Each of these adjusters 140, 142, 144 provides 6 DOF of positional adjustability of the respective mirror and typically is a “set-and-forget” device that, once set, can be left in its respective adjusted position (at least until adjustment is again required). The second condenser mirror (CON2) 146 can have a respective 6DOF adjuster (not shown) if desired. Determinations of the positions of the FE/CON frame 106 and projection-optics box 128 relative to each other are made by an appropriate sensor 148 across a tracking interface 150. The sensor 148 provides feedback to the 6DOF mounting 126. Thus, using the 6DOF mounting 126, the FE/CON frame 106 actively tracks the position of the projection-optics box 128. The sensor 148, served by a flexible cable (not shown) desirably is mounted to the FE/CON frame 106 rather than to the projection-optics box 128 to simplify routing of cables and the like (not shown).

A “tracking interface” comprises two principal surfaces, one on each body to be aligned with each other. The tracking interface includes at least one sensor (e.g., interferometer, capacitative sensor, inductive sensor, laser scale, or optical sensor) used for measuring the relative distance between the two principal surfaces of the tracking interface. Typically, the sensor is attached to one of the principal surfaces. In some instances, multiple components of the sensor need to be attached to both principal surfaces. For example, in the case of an interferometric sensor, mirrors usually need to be placed on both principal surfaces.

The configuration shown in FIG. 4 is an example of a two-body active-stabilization configuration, in which the FE/CON frame 106 actively tracks the projection-optical box (POB) 128 using the 6DOF mounting 126, and the COL frame 104 actively tracks the FE/CON frame 106 using the 6DOF mounting 120.

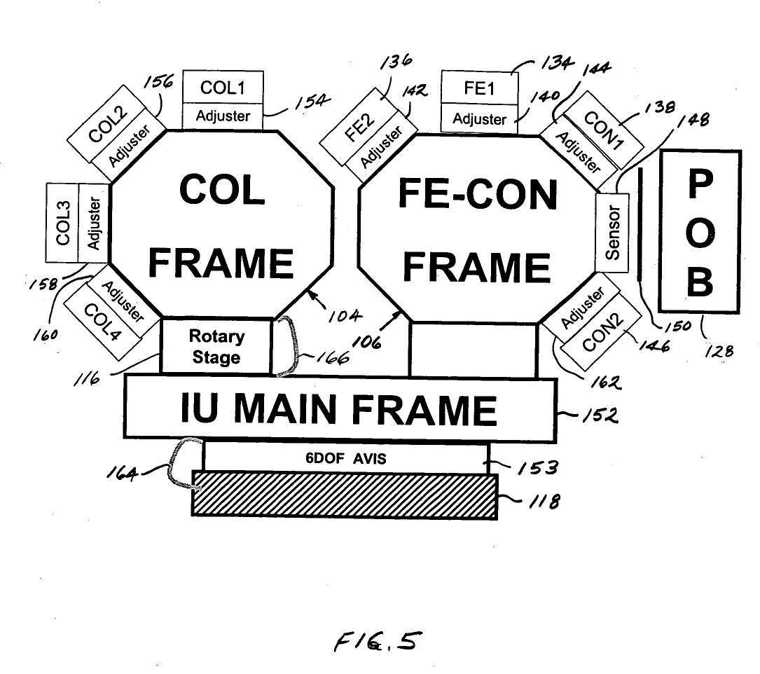

An alternative configuration is depicted in FIG. 5, in which components that are similar to respective components shown in FIG. 4 have the same reference designators. In FIG. 5 the COL frame 104 (configured as a turret containing multiple collimator mirrors) and the FE/CON frame 106 (containing a set of fly-eye mirrors and a set of condenser mirrors) are mounted to an illumination-optical-system (IU) “main frame” 152. The IU main frame 152 is mounted to the system base 118 via a 6DOF mounting 153 that includes active vibration isolation (AVIS) and 6 DOF of positional adjustability. The rotary stage 116, in turn, is mounted to the IU main frame 152, and the COL frame 104 is mounted to the rotary stage 116. Each collimator mirror COL1 -COL4 is mounted to its respective branch of the COL frame 104 using a respective adjuster 154, 156, 158, 160 each providing 6 DOF of positional adjustability of the respective mirror as well as a mounting for the mirror. Each adjuster 154, 156, 158, 160 can be a respective “set-and-forget” device.

The FE/CON frame 106 for the fly-eye mirrors 134, 136 and condenser mirrors 138, 146 is also mounted to the IU main frame 152. Each of the mirrors 134, 136, 138, 146 includes a respective adjuster 140, 142, 144, 162 each providing 6 DOF of positional adjustability of the respective mirror. Each adjuster 140, 142, 144, 162 desirably can be a respective “set-and-forget” device.

Determinations of the positions of the IU main frame 152 (and thus of the FE/CON frame 106 and COL frame 104) and projection-optics box 128 relative to each other are made by the sensor 148 across the tracking interface 150. The sensor 148 provides feedback to the 6DOF mounting 153. Thus, using the 6DOF mounting 153, the IU main frame 152 (and thus the FE/CON frame 106 and COL frame 104) actively track the position of the projection-optics box 128.

The configuration of FIG. 5 is an example of a one-body active-stabilization configuration, in which the FE/CON frame 106 and the COL frame 104 are mounted to the IU main frame 152, and the IU main frame 152 tracks the projection-optical box 128 using the 6DOF mounting 153. An advantage of the configuration of FIG. 5 is simplicity of routing of cables and hoses 164, 166 from stationary portions to movable portions of the system.

As noted above, each of the collimator mirrors COL1-COL4 in the embodiment of FIG. 5 desirably are mounted to the COL frame 104 via a respective adjuster 154, 156, 158, 160 providing an individual mounting for the mirror as well as 6 DOF of positional adjustability of the mirror. An especially desirable adjuster for this purpose is a “KALM” kinematic mounting as described in U.S. Published Patent Application No. U.S. 2002/0163741 A1, incorporated herein by reference. A KALM mounting can utilize any of various types of actuators, including but not limited to, piezoelectric (PZT) actuator with strain gauge, pico motor with encoder, stepper motor with micrometer (μmeter) and encoder, and voice-coil motor (VCM) with inductive sensor. Various parametric data concerning these actuators are set forth in Table 1, below. These data are based on the following assumptions:
mirror mass=10 kg
frame mass=100 kg

first mode=150 Hz

TABLE 1

| | Requirement | PZT + strain | | | VCM + inductive |
|---|---|---|---|---|---|
| Parameter | for mirror | gauge | Pico motor + encoder | Step motor + μmeter + encoder | sensor |
| Resolution | 1 μm | 4 nm | 65 nm | 0.1 μm | 10 nm |
| Range | 5 mm | 180 μm | 10 mm | 20 mm | 5 mm |
| Force (vert) | 100 N | 4500 N | 22 N | 120 N | 100 N |
| Force | 10 N | 500 N | 22 N | 120 N | 1000 N |
| (horiz) | | | | | |
| Stiffness* | 10 N/μm | 35 N/μm | ˜15 N/μm | ˜15 N/μm | >10 N/μm |
| Hold Power | zero | low | zero | zero | high |
| Actuator | | 0.4 kg | 0.1 kg | 0.6 kg | 1 kg |
| mass | | | | | |
| Actuator | | Ø25 × 185 mm | ˜50 × 50 × 50 mm | Ø50 × 170 mm | 50 × 50 × 30 mm |
| size | | | | | |
| Manually | yes | no | yes | yes | no |
| adjustable? | | | | | |
| Mfr | | PI | Newfocus | PI | Micro- |
| | | | | | Epsilon |

*An actuator's effective stiffness could be increased at the expense of the effective stroke of the actuator by employing an appropriate transmission element (e.g., lever with flexural hinge).

As noted above, the IU main frame 152 is mounted to the system base 118 via a 6DOF mounting 153 providing 6 DOF of positional adjustability of the IU main frame 152 as well as vibrational isolation. The 6DOF mounting 153 can include any of several types of actuators, including but not limited to, stepper motor with micrometer (μmeter), encoder, and air bellows; and voice-coil motor (VCM) with inductive sensor and air bellows. Various parametric data concerning these actuators are set forth in Table 2, below. These data are based on the following assumptions:
mirror mass=10 kg
frame mass=100 kg

first mode=150 Hz

TABLE 2

| | Requirement | Stepper motor + | VCM + inductive |
|---|---|---|---|
| | for | μmeter + encoder + air | sensor + |
| Parameter | frame | bellows | air bellows |
| Resolution | 1 μm | 0.1 μm | 10 nm |
| Range | 5 mm | 20 mm | 5 mm |
| Force (vert) | 1000 N | 1000 N | 100 N |
| Force (horiz) | 100 N | 120 N | 1000 N |
| Stiffness* | 100 N/μm | ˜15 N/μm | >100 N/μm |
| Hold Power | zero | zero | low |
| Actuator mass | | 0.6 kg | 5 kg |
| Actuator size | | Ø50 × 170 mm | 50 × 50 × 30 mm |
| Manually | yes | yes | no |
| adjustable? | | | |
| Mfr | | PI | Micro-Epsilon |

*An actuator's effective stiffness could be increased at the expense of the effective stroke of the actuator by employing an appropriate transmission element (e.g., lever with flexural hinge).

Advantages of the stepper motor plus micrometer plus encoder plus air bellows are: (a) no holding power, and (b) usability as a “set-and-forget” device; disadvantages are inability to provide vibration isolation. Advantages of the VCM plus inductive sensor plus air bellows are: (a) ability to provide vibration isolation if required, and (b) adequate stiffness; disadvantages are requirement for active control, and inability to be manually adjusted. Hence, vibration isolation is the primary distinguishing performance-based characteristic between these actuators.

This embodiment provides an illumination-optical system including an exchanger providing multiple selectable collimator mirrors. Thus, a collimator mirror currently in use can be replaced with a new one, clean one, or different one quickly, without having to shut the system down. Indeed, the collimator frame can be configured to replace the collimator mirror automatically such as after a defined operation time or upon an excessive amount of debris or other contamination has accumulated on the collimator mirror currently in use. The collimator frame also provides multiple collimator mirrors in a small operating volume of space. Furthermore, because there is no physical contact of, for example, the collimator frame with the FE/CON frame, exchanges of the collimator mirror can be performed with minimal disturbance to other optical components that are not being replaced, which improves alignment time after the mirror exchange and facilitates mirror exchanges being performed with less particle generation. Thus, system contamination is reduced and system productivity is increased. The actuators and sensors associated with the collimator mirrors and with the collimator frame serve to position and stabilize the mirrors and frame relative to a reference frame such as the projection-optics box. Finally, the collimator frame can be readily housed in a vacuum chamber that can be provided easily with an opening providing access to the collimator mirrors.

### Second Representative Embodiment

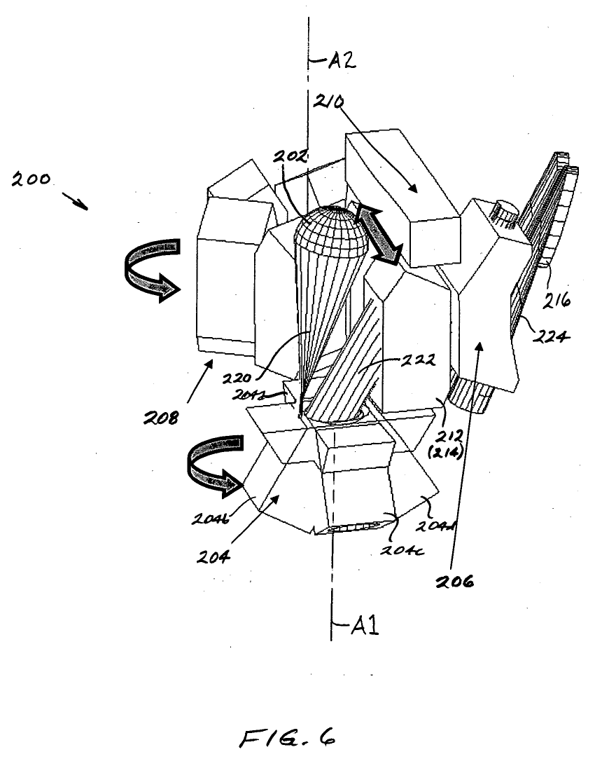

This embodiment, depicted in FIG. 6, provides an illumination-optical system 200 in which the collimator mirror as well as the fly-eye-mirror set (consisting of the first and second fly-eye mirrors) can be exchanged in order to provide a range in sigma (σ) from, for example, 0.3 to 0.8. To provide this performance, the respective positions of the first fly-eye mirror and the collimator mirror change as much as 200 mm, and the respective diameters of the first fly-eye mirror, second fly-eye mirror, and collimator mirrors change as much as 150 mm. The embodiment of FIG. 6 depicts the following components: the collector mirror 202 of the EUV source (the remainder of the EUV source is not shown, but see FIG. 1); a four-way exchanger or turret (termed the COL frame) 204 containing an ensemble of four selectable collimator mirrors (similar to the first representative embodiment); a “CON frame” 206 containing a set of first and second condenser mirrors; a rotary frame-storage device 208 holding an ensemble of six selectable “fly-eye frames” (FE frames); an FE-frame exchanger 210 that moves a selected FE frame 212 from the frame-storage device 208 to an operational position 214 at which the selected FE frame is aligned with the selected collimator mirror and with the CON frame 206; and a grazing-incidence mirror 216. Thus, this embodiment differs from the first representative embodiment in providing an ensemble of multiple fly-eye-mirror sets that can be individually selected as desired or required. Each of the fly-eye-mirror sets, although termed a respective “fly-eye frame” herein, is configured as a separate fly-eye-mirror “module” including a respective housing for the respective fly-eye-mirror set.

The COL frame 204 includes four independently selectable branches 204a-204d each containing a respective collimator mirror. The COL frame 204 is rotatable about an axis A1 to position a selected branch 204a-204d relative to the selected FE frame 212. The respective collimator mirrors in the branches 204a-204d can be the same or different. For example, the branches 204a-204d can provide four different respective collimator mirrors each having a different size, a different surface profile, and/or a different position to provide four different respective optical settings. Alternatively, two or more of the collimator mirrors can be identical, in which configuration the COL frame 204 allows exchange of a contaminated collimator mirror for a clean or new one by simply rotating the COL frame 204 to a different branch containing the clean or new mirror. Note that, in this embodiment, only one selected branch 204a-204d can be in an operational position 218 at which the respective mirror can receive EUV light 220 from the collector mirror 202. EUV light 222 reflected from the collimator mirror in the selected branch exits the COL frame 204 and enters the selected FE frame 212 as the light propagates to the first fly-eye mirror situated in the selected FE frame 212. In the FE frame 212 the EUV light reflects, in succession, from the first fly-eye mirror and the second fly-eye mirror. The EUV light then passes from the selected FE frame 212 to the CON frame 206, in which the EUV light reflects, in succession, from the first condenser mirror and the second condenser mirror. EUV light 224 reflected from the second condenser mirror exits the CON frame 206 as the light 224 propagates to the grazing-incidence mirror 216.

Referring to FIG. 7, the COL frame 204 is mounted on a rotary stage 260 mounted to a system base 230. The rotary stage 260 is rotatable relative to the base 230 to rotate the COL frame 204 relative to the base 230 as required to select a particular branch 204a-204d. Between the stage 260 and the COL frame 204 is a mounting 262 providing an active vibration-isolation system (AVIS) and six degrees of freedom (6 DOF) of actuation motion (x, y, z, θₓ, θ_{y}, θ_{z}) of the COL frame (for positional-adjustment and vibration-isolation purposes) relative to the stage 260. Thus, the mounting 262 serves as a “fine stage” for the rotary stage 260, wherein the rotary stage 260 includes and serves as a coarse stage (not detailed). In FIG. 7, the branch 204c, containing “collimator 3” (“COL3”), has been selected for use. Thus, the 6DOF mounting 262 imparts active vibration isolation and 6 DOF of positional adjustability of the branch 204c, and hence of the collimator mirror COL3. Since the 6DOF mounting 262 serves the entire COL frame 204, individual 6DOF mountings are not required for each collimator mirror COL1-COL4 (COL 4 not shown). This alleviates system complexity and simplifies routing of flexible hoses (for hydraulics) and electrical cables 264 extending between the base 230 and the rotary stage 260 and of hoses and cables 266 extending between the rotary stage 260 and the collimator mirrors COL1-COL4 in the COL frame 204.

The rotary frame-storage device 208 holds an ensemble of multiple (e.g., six as shown) independently selectable FE frames 226a-226f each containing a respective counterpart set of first and second fly-eye mirrors. Each counterpart set is contained in a respective housing. The rotary frame-storage device 208 is rotatable about an axis A2 to position a particular FE frame (e.g., 226f) for movement by the FE-frame exchanger 210. To achieve this rotation, the rotary frame-storage device 208 is mounted on a rotary stage 228 that is mounted to the system base 230. The respective sets of fly-eye mirrors in the FE frames 226a-226f can be the same or different. For example, the FE frames 226a-226f can provide six different respective sets of fly-eye mirrors having different shapes and different distances between them to provide six different respective optical settings. Alternatively, two or more of the fly-eye sets can be identical, in which configuration the rotary frame-storage device 208 allows exchange of a contaminated set of fly-eye mirrors for a clean or new set by simply rotating the frame-storage device 208 to a different position providing the FE frame containing the clean or new mirrors.

The FE-frame exchanger 210 in this embodiment comprises a linear stage 232 that moves a link 234 from a first position 236a (at the rotary frame-storage device 208) to a second position 236b (at the operational position 214). The link 234 is configured to interact with the selected FE frame 212 in a manner by which the selected FE frame is moved, with corresponding motion of the link 234, from the first position 236a to the second position 236b. The link 234 is mounted to the linear stage 232 via a 6DOF mounting 238 that desirably also provides active vibration isolation (AVIS) between the linear stage 232 and the link 234. Upon the selected FE frame 212 being placed at the operational position 214, the link 234 remains attached to the selected FE frame 212; thus, the 6DOF mounting 238 provides motion of the selected FE frame 212 as required to align the selected FE frame with the selected branch of the COL frame 204 and with the CON frame 206.

Desirably, the COL frame 204 does not physically contact the selected FE frame 212, either during rotation of the COL frame, during use of the selected branch of the COL frame, during placement of the selected FE frame 212 at the operational position 214, or during use of the selected FE frame 212. Each branch of the COL frame 204 has a respective sensor 240a-240d (only three, 240a-240c, are shown in FIG. 7) that senses positional alignment, across a tracking interface 242, of the respective branch with the selected FE frame 212 at the operational position 214. Data from the sensor 240 is used as feedback to the 6DOF mounting 238.

In each FE frame 226a-226f, the first respective fly-eye mirror FE1 can be mounted to a respective 6DOF adjuster 244 that provides 6 DOF of positional adjustment of that fly-eye mirror FE1 relative to the FE frame 226 and to the second respective fly-eye mirror FE2 (FIG. 7). The second respective fly-eye mirror FE2 need not have such an adjuster, but can include an adjuster, if desired, providing six or fewer degrees of freedom of motion. Each 6DOF adjuster 244 can be configured as a “set-and-forget” type of adjuster.

The CON frame 206 is mounted to the system base 230 via a respective 6DOF mounting 246 that desirably also provides active vibration isolation (AVIS) of the CON frame 206 relative to the system base 230. Thus, the CON frame can move as required to achieve accurate alignment with the selected FE frame 212 at the operational position 214 and with the projection-optics box (POB) 248. The CON frame 206 has a first sensor 250 and a second sensor 252 for sensing these alignments. Specifically, the first sensor 250 senses alignment with the selected FE frame 212 across a first tracking interface 254, and the second sensor 252 senses alignment with the projection-optics box 248 across a second tracking interface 256. Data from the sensors 250, 252 is fed back to the 6DOF mounting 246.

In the CON frame, the first respective condenser mirror CON1 can be mounted to a respective 6DOF adjuster 258 that provides 6 DOF of positional adjustment of that condenser mirror CON1 relative to the CON frame 206 and to the second respective condenser mirror CON2 (FIG. 7). The second respective condenser mirror CON2 need not have such an adjuster, but can include an adjuster, if desired, providing six or fewer degrees of freedom of motion. Each 6DOF adjuster 258 can be configured as a “set-and-forget” type of adjuster.

Based on the foregoing description, this embodiment exhibits three-body active stabilization, achieved by the 6DOF mountings 238, 246, 262 (for the FE frame 226, CON frame 206, and COL frame 204, respectively). This particular configuration also minimizes the number of flexible hoses and cables that must be extended to each of the frames 204, 206, 226 (in FIG. 7 see cables and hoses 264, 266, 268, 270, 272, 274).

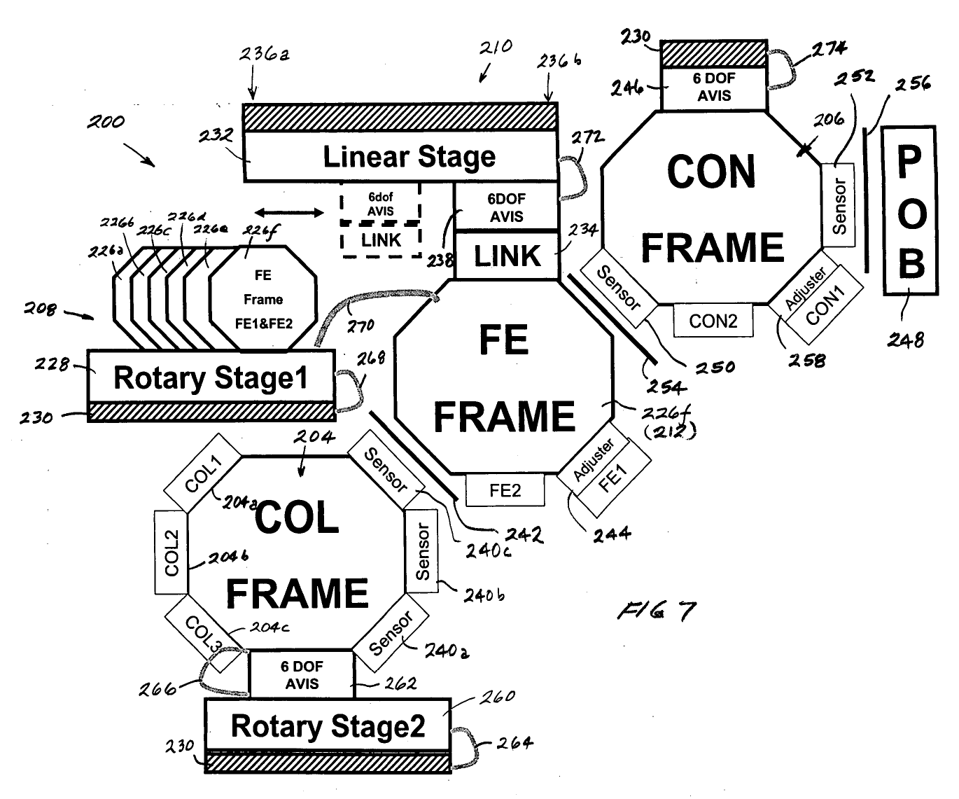

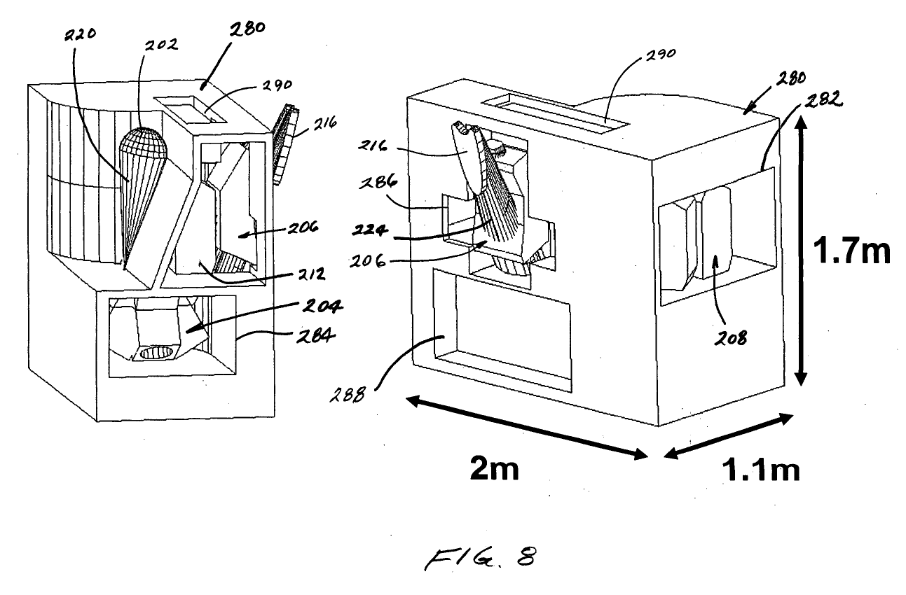

Referring now to FIG. 8, a housing 280 is shown that encloses substantially the entire illumination-optical system 200. Exemplary dimensions also are shown. The housing 280 defines a first opening 282 for accessing the FE frames on the rotary stage 228. Thus, one or more of the FE frames 226a-226f can be removed for cleaning, replacement, or adjustment, for example. The housing 280 also defines a second opening 284 for accessing the COL frame 204 for cleaning, replacement, or adjustment of any of the collimator mirrors COL1-COL4. (To such end, each of the branches 204a-204d of the COL frame 204 can be independently detachable from the COL frame 204 for ease of removal without disturbing any of the remaining branches.) The housing 280 also defines a third opening 286 providing access to the CON frame 206 and through which the beam 224 propagates to the grazing-incidence mirror 216 and then to the reticle (not shown). The housing also defines a fourth opening 288 through which, for example, the wafer stage (not shown) can extend, and a fifth opening 290 for access to, for example, the linear stage 232. The housing 280 is compact and space-efficient, and thus facilitates efficient evacuation (using appropriate vacuum pumps) of the atmosphere inside, while retaining accessibility to the components inside for quick service, cleaning, replacement, or the like.

### Third Representative Embodiment

Relevant features of this embodiment are depicted in FIG. 9, which depicts an illumination-optical system 300 that receives EUV radiation 302 from a source (only the collector mirror 304 is shown). The illumination-optical system includes a condenser frame (CON frame) 306 that includes a set of first and second condenser mirrors (not detailed). From the second condenser mirror the EUV light flux 308 propagates to the grazing-incidence mirror 310 and then to a reticle (not shown). The illumination-optical system 300 also includes a rotary frame-storage device 312 comprising an ensemble of multiple selectable fly-eye/collimator (FEC) frames 314a-314f. Each FEC frame 314a-314f is configured as a separate housing or “module” containing the respective set of fly-eye mirrors and collimator mirror. A selected FEC frame (e.g., frame 314f) is moved from the frame-storage device 312 to an operational position 316 by a linear FEC-frame exchanger (not shown, but similar to the FE-frame exchanger 210 of the second representative embodiment). The rotary frame-storage device 312 is configurationally and operationally similar to the rotary frame-storage device 208 of the second representative embodiment.

This embodiment can be used, for example, whenever (1) the number of selectable collimator mirrors can be equal to the number of selectable fly-eye-mirror sets, and (2) it is unnecessary that the collimator mirrors be selectable independently of the fly-eye-mirror sets.

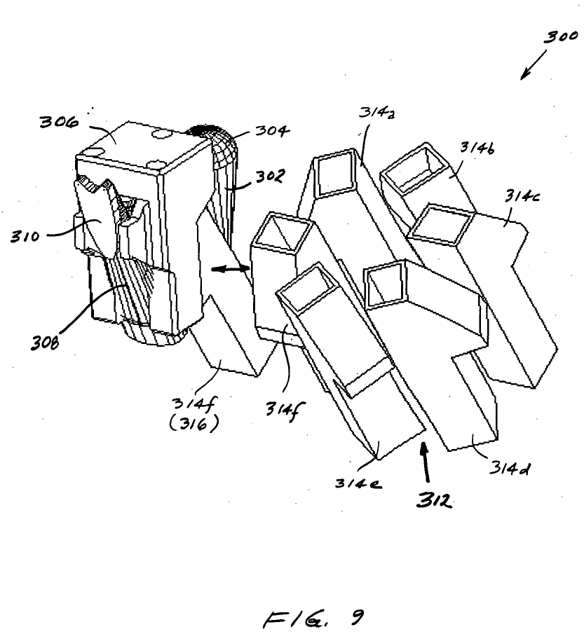

Turning to FIG. 10, an exemplary housing 318 for the CON frame 306 and selected FEC frame 314 in the operational position 316 is shown. The housing 318 also can contain the EUV source (note position of collector mirror 304) desirably supported on a separate structure (not detailed) in the housing 318. The housing 318 includes space 320 for the linear FEC-frame exchanger and defines an opening 322 through which the selected FEC frame 314 is moved from the rotary frame-storage device 312 to the operational position 316. An advantage of this embodiment is its ability to accommodate vacuum pumps close to the optical path in the illumination-optical system. For example, attached to a side wall 324 of the housing 318 are vacuum pumps 326a-326d (e.g., turbomolecular pumps each having a pump rate of 3600 L/s) for evacuating the illumination-optical system and projection-optics box (not shown), and vacuum pumps 328a-328c (e.g., turbomolecular pumps each having a pump rate of 3600 L/s) for evacuating the EUV source.

### Fourth Representative Embodiment

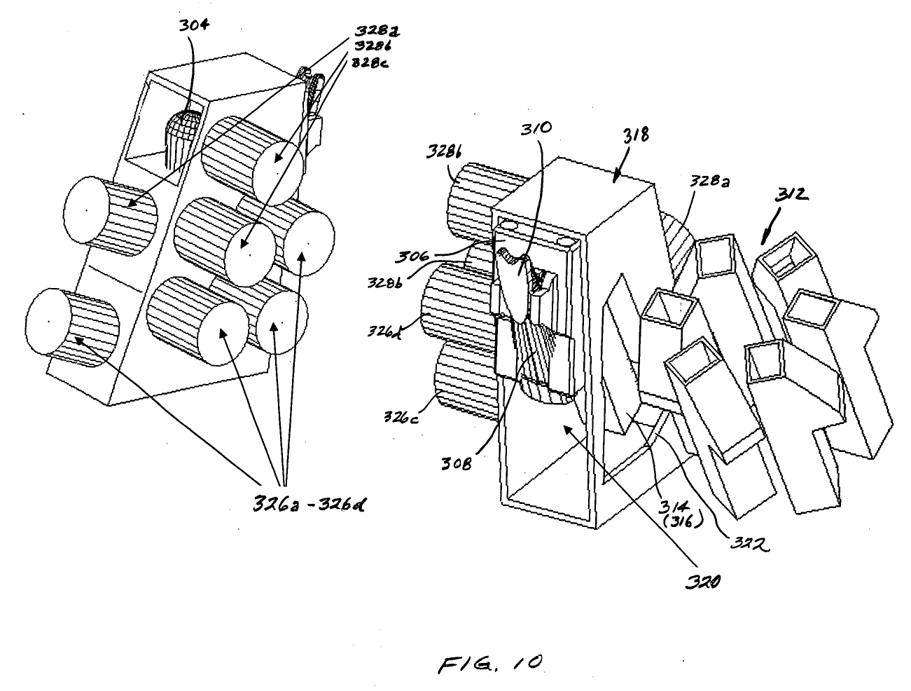

Relevant features of this embodiment are depicted in FIG. 11, which depicts an illumination-optical system 350 that receives EUV radiation 352 from a source (only the collector mirror 354 is shown). The illumination-optical system 350 includes a condenser frame (CON frame) 356 that includes a set of first and second condenser mirrors (not detailed). From the second condenser mirror the EUV light flux 358 propagates to the grazing-incidence mirror 360 and then to a reticle (not shown). The illumination-optical system 350 also includes an ensemble of multiple selectable fly-eye/collimator (FEC) frames 364a-364f that are storable on both sides of the CON frame 356. Each FEC frame 364a-364f is configured as a separate housing or “module” containing the respective set of fly-eye mirrors and collimator mirror. A desired FEC frame (e.g., frame 364f) is selected and moved into an operational position 366 by a combination of linear motions 368a, 368b in the X and Z directions, respectively. These motions 368a, 368b can be effected, for example, by respective linear actuators (not shown, but similar to the FE-frame exchanger 210 in the second representative embodiment) or by an X, Z robot. Similar to the third representative embodiment, this embodiment can be used, for example, whenever (1) the number of selectable collimator mirrors can be equal to the number of selectable fly-eye-mirror sets, and (2) it is unnecessary that the collimator mirrors be selectable independently of the fly-eye-mirror sets. Advantages of this embodiment include compactness and simple robotics.

### Fifth Representative Embodiment

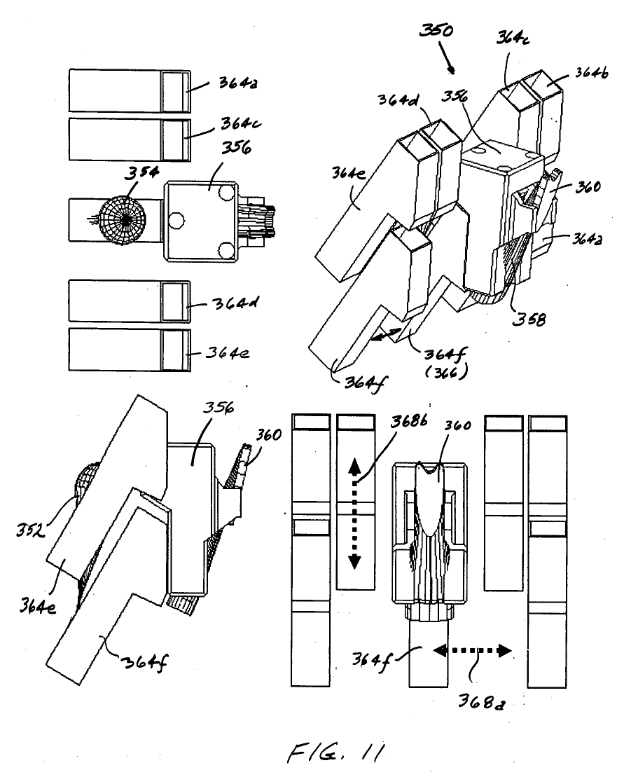

Relevant features of this embodiment are depicted in FIG. 12, which depicts an illumination-optical system 400 that receives EUV radiation 402 from a source (only the collector mirror 404 is shown). The illumination-optical system 400 includes a condenser frame (CON frame) 406 that includes a set of first and second condenser mirrors (not detailed). From the second condenser mirror the EUV light flux 408 propagates to the grazing-incidence mirror 410 and then to a reticle (not shown). The illumination-optical system 400 includes an ensemble of multiple selectable fly-eye/collimator (FEC) frames 414a-414f that are storable on one side of the CON frame 406. Each FEC frame 414a-414f is configured as a separate housing or “module” containing the respective set of fly-eye mirrors and collimator mirror. A desired FEC frame (e.g., frame 414f) is selected and moved into an operational position 416 by a combination of linear motions (see fourth representative embodiment) in the X and Z directions. These motions can be effected, for example, by respective linear actuators (not shown, but similar to the FE-frame exchanger 210 in the second representative embodiment) or by an X-Z robot. Similar to the third representative embodiment, this embodiment can be used, for example, whenever (1) the number of selectable collimator mirrors can be equal to the number of selectable fly-eye-mirror sets, and (2) it is unnecessary that the collimator mirrors be selectable independently of the fly-eye-mirror sets.

Advantages of this embodiment include the ability to accommodate vacuum pumps placed close to the optical path of the illumination-optical system, compactness, and simple robotics.

### Sixth Representative Embodiment

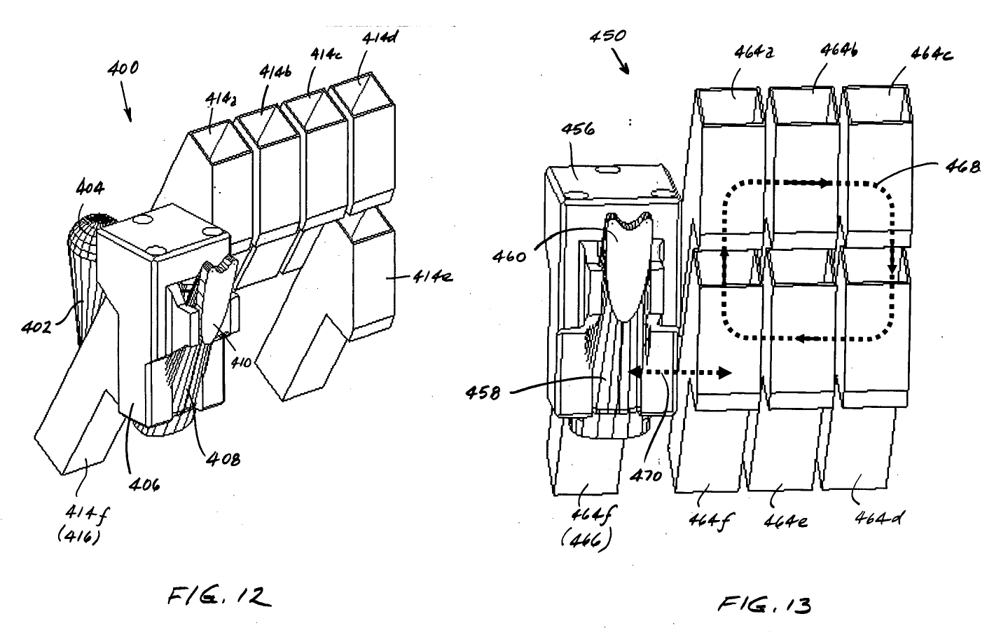

Relevant features of this embodiment are depicted in FIG. 13, which depicts an illumination-optical system 450 that receives EUV radiation from a source (not shown). The illumination-optical system 450 includes a condenser frame (CON frame) 456 that includes a set of first and second condenser mirrors (not detailed). From the second condenser mirror the EUV light flux 458 propagates to the grazing-incidence mirror 460 and then to a reticle (not shown). The illumination-optical system 450 includes an ensemble of multiple selectable fly-eye/collimator (FEC) frames 464a-464f that are storable on one side of the CON frame 456. Each FEC frame 464a-464f is configured as a separate housing or “module” containing the respective set of fly-eye mirrors and collimator mirror. A desired FEC frame (e.g., frame 464f) is selected and moved into an operational position 466 by a combination of rotary motion (arrows 468) and linear motion (arrows 470). The rotary motion 468 can be effected by a rotary stage or the like (see rotary frame-storage device 208 in the second representative embodiment), and the linear motion 470 can be effected by a linear exchanger (see FE-frame exchanger in the second representative embodiment). Similar to the third representative embodiment, this embodiment can be used, for example, whenever (1) the number of selectable collimator mirrors can be equal to the number of selectable fly-eye-mirror sets, and (2) it is unnecessary that the collimator mirrors be selectable independently of the fly-eye-mirror sets.

Advantages of this embodiment include the ability to accommodate vacuum pumps close to the optical path of the illumination-optical system, compactness, and rapid exchange time.

### Seventh Representative Embodiment

Relevant features of this embodiment are depicted in FIG. 14, which depicts an illumination-optical system 500 that receives EUV radiation 502 from a source (not shown). The illumination-optical system 500 includes a condenser frame (CON frame) 506 that includes a set of the first and second condenser mirrors (not detailed). From the second condenser mirror the EUV light flux 508 propagates to the grazing-incidence mirror 510 and then to a reticle (not shown). The illumination-optical system 500 includes an ensemble of multiple selectable fly-eye/collimator (FEC) frames 514a-514f that are storable on one side of the CON frame 506. Each FEC frame 514a-514f is configured as a separate housing or “module” containing the respective set of fly-eye mirrors and collimator mirror. A desired FEC frame (e.g., frame 514f) is selected and moved into an operational position 516 by a combination of linear motions (see fourth representative embodiment) in the X and Z directions. These motions can be effected, for example, by respective linear actuators (not shown, but similar to the FE-frame exchanger 210 in the second representative embodiment) or by an X-Z robot. Similar to the third representative embodiment, this embodiment can be used, for example, whenever (1) the number of selectable collimator mirrors can be equal to the number of selectable fly-eye-mirror sets, and (2) it is unnecessary that the collimator mirrors be selectable independently of the fly-eye-mirror sets.

Advantages of this embodiment include the ability to accommodate vacuum pumps placed close to the optical path of the illumination-optical system, a simple exchange mechanism (X-Z robot), and rapid exchange time.

### Eighth Representative Embodiment

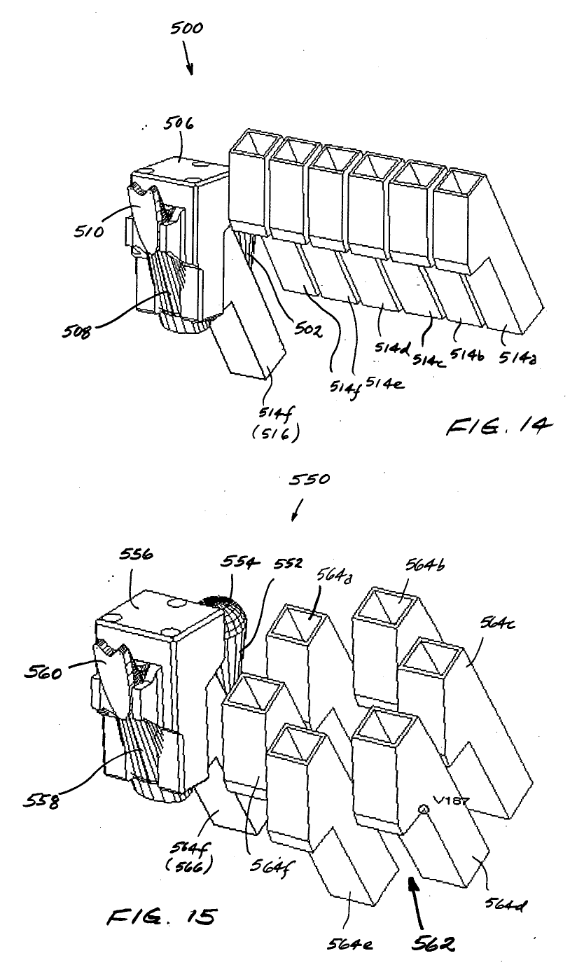

Relevant features of this embodiment are depicted in FIG. 15, which depicts an illumination-optical system 550 that receives EUV radiation 552 from a source (only the collector mirror 554 is shown). The illumination-optical system 500 includes a condenser frame (CON frame) 556 that includes a set of the first and second condenser mirrors (not detailed). From the second condenser mirror the EUV light flux 558 propagates to the grazing-incidence mirror 560 and then to a reticle (not shown). The illumination-optical system 550 also includes a rotary frame-storage device 562 comprising an ensemble of multiple selectable fly-eye/collimator (FEC) frames 564a-564f. Each FEC frame 564a-564f is configured as a separate housing or “module” containing the respective set of fly-eye mirrors and collimator mirror. A selected FEC frame (e.g., frame 564f) is moved from the frame-storage device 562 to an operational position 566 by a linear FEC-frame exchanger (not shown, but similar to the FE-frame exchanger 210 of the second representative embodiment). The rotary frame-storage device 562 is analogous to the rotary frame-storage device 208 of the second representative embodiment, but since the FEC frames all remain in the same orientation, the mechanism of the rotary frame-storage device 562 is more complex than of the frame-storage device 208.

Similar to the third representative embodiment, this embodiment can be used, for example, whenever (1) the number of selectable collimator mirrors can be equal to the number of selectable fly-eye-mirror sets, and (2) it is unnecessary that the collimator mirrors be selectable independently of the fly-eye-mirror sets.

### Ninth Representative Embodiment

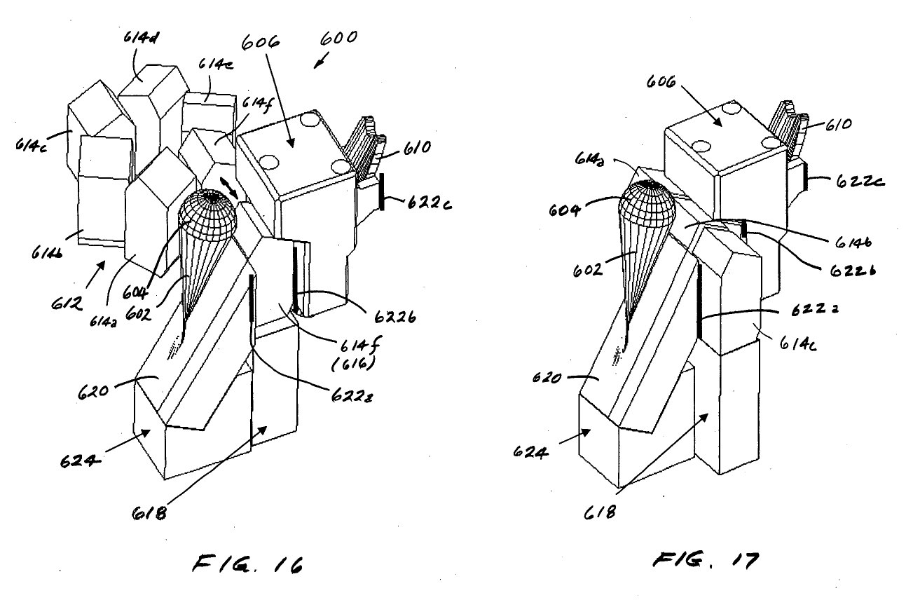

Relevant features of this embodiment are depicted in FIG. 16, which depicts an illumination-optical system 600 that receives EUV radiation 602 from a source (only the collector mirror 604 is shown). The illumination-optical system 600 includes a condenser frame (CON frame) 606 that includes a set of first and second condenser mirrors (not detailed). The CON frame 606 is supported, relative to a system base (not shown) by a 6DOF mounting including AVIS. This 6DOF mounting is not shown, but see, for example, item 126 in FIG. 4. From the second condenser mirror the EUV light flux propagates to the grazing-incidence mirror 610 and then to a reticle (not shown). The illumination-optical system 600 also includes a rotary frame-storage device 612 comprising an ensemble of multiple selectable fly-eye (FE) frames 614a-614f. Each FE frame 614a-614f is configured as a separate housing or “module” containing the respective set of fly-eye mirrors and collimator mirror. A selected FE frame (e.g., frame 614f) is moved from the frame-storage device 612 to an operational position 616 by a linear FE-frame-exchanger robot 618 (similar to the FE-frame exchanger 210 of the second representative embodiment). The FE-frame-exchanger robot 618 has a long stroke in the X direction and is supported by a 6DOF mounting including AVIS. At the operational position 616 the selected FE frame is situated between the CON frame 606 and the COL frame 620. A respective tracking interface 622a is situated between the COL frame 620 and the selected FE frame 614f, a respective tracking interface 622b is situated between the selected FE frame 614f and the CON frame 606, and a respective tracking interface 622c is situated between the CON frame 606 and the projection-optics box. Thus, this embodiment provides non-contacting, active kinematic coupling of the frames (including the selected FE frame) with each other and with the main IU frame.

If desired, this embodiment can be provided with an ensemble of multiple selectable COL frames associated with a suitable exchanger 624 such as any of the various exchangers described above. This embodiment also provides good management of hoses and cables, allows placement of vacuum pumps near the EUV optical pathways, is compact and scalable, allows fast exchange time, and utilizes a low number of actuators.

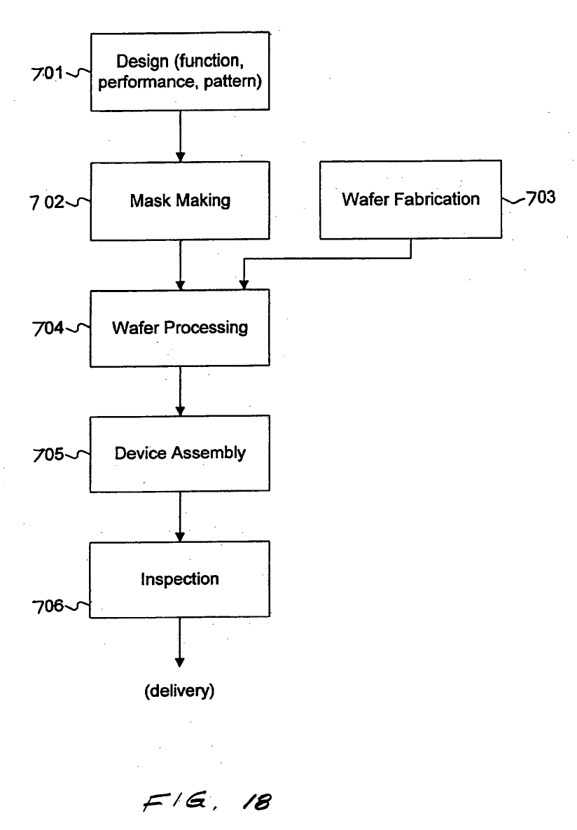

An alternative configuration is shown in FIG. 17, in which the rotary frame-storage device 612 is eliminated, and a selected one FE frame 614b (of multiple such frames, three of which 614a, 614b, 614c are shown) is placed in the operational position 616 using the FE-frame-exchanger robot 618 only. Advantages of this configuration are: (a) compact and scalable, (b) fast exchange time, (c) simpler exchange mechanism than the embodiment shown in FIG. 16, (d) simpler management of hoses and cables than the embodiment shown in FIG. 16.

An EUVL system including the above-described illumination-optical system can be constructed by assembling various assemblies and subsystems in a manner ensuring that prescribed standards of mechanical accuracy, electrical accuracy, and optical accuracy are met and maintained. To establish these standards before, during, and after assembly, various subsystems (especially the illumination-optical system and projection-optical system) are assessed and adjusted as required to achieve the specified accuracy standards. Similar assessments and adjustments are performed as required of the mechanical and electrical subsystems and assemblies. Assembly of the various subsystems and assemblies includes the creation of optical and mechanical interfaces, electrical interconnections, and plumbing interconnections as required between assemblies and subsystems. After assembling the EUVL system, further assessments, calibrations, and adjustments are made as required to ensure attainment of specified system accuracy and precision of operation. To maintain certain standards of cleanliness and avoidance of contamination, the EUVL system (as well as certain subsystems and assemblies of the system) are assembled in a clean room or the like in which particulate contamination, temperature, and humidity are controlled.

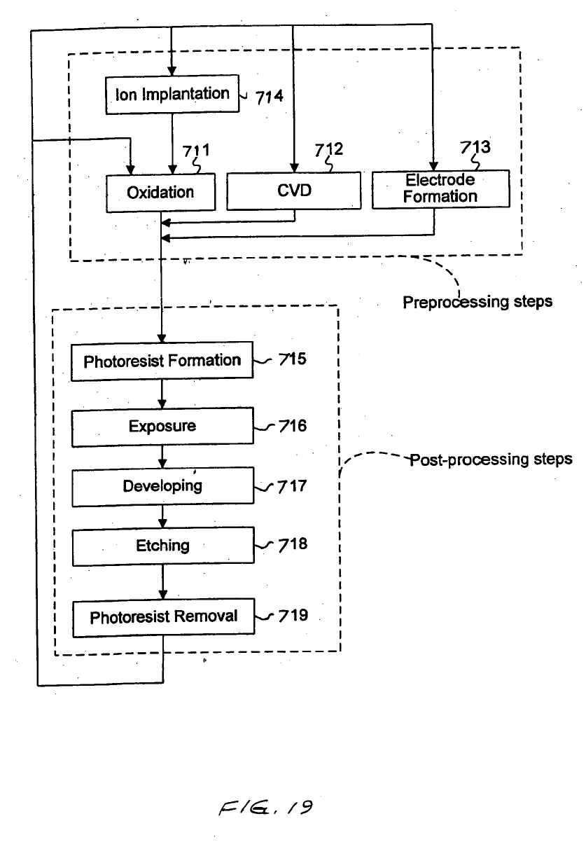

Semiconductor devices can be fabricated by processes including microlithography steps performed using a microlithography system as described above. Referring to FIG. 18, in step 701 the function and performance characteristics of the semiconductor device are designed. In step 702 a reticle defining the desired pattern is designed according to the previous design step. Meanwhile, in step 703, a substrate (wafer) is made and coated with a suitable resist. In step 704 the reticle pattern designed in step 702 is exposed onto the surface of the substrate using the microlithography system. In step 705 the semiconductor device is assembled (including “dicing” by which individual devices or “chips” are cut from the wafer, “bonding” by which wires are bonded to the particular locations on the chips, and “packaging” by which the devices are enclosed in appropriate packages for use). In step 706 the assembled devices are tested and inspected.

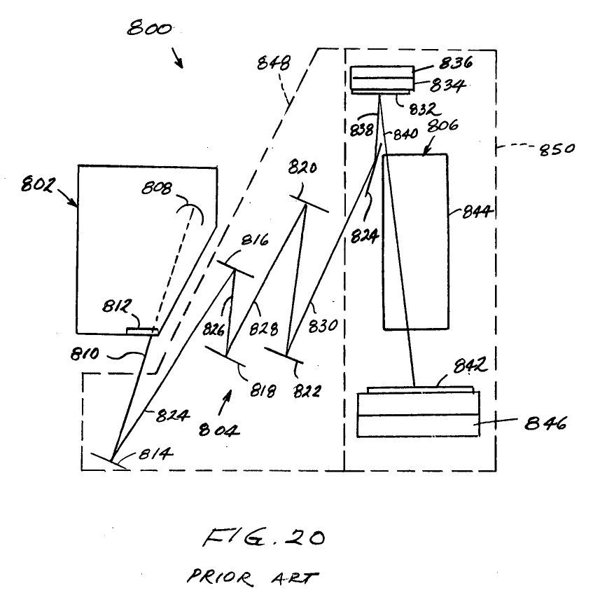

Representative details of a wafer-processing process including a microlithography step are shown in FIG. 19. In step 711 (oxidation) the wafer surface is oxidized. In step 712 (CVD) an insulative layer is formed on the wafer surface. In step 713 (electrode formation) electrodes are formed on the wafer surface by vapor deposition for example. In step 714 (ion implantation) ions are implanted in the wafer surface. These steps 711-714 constitute representative “pre-processing” steps for wafers, and selections are made at each step according to processing requirements.

At each stage of wafer processing, when the pre-processing steps have been completed, the following “post-processing” steps are implemented. A first post-process step is step 715 (photoresist formation) in which a suitable resist is applied to the surface of the wafer. Next, in step 716 (exposure), the microlithography system described above is used for lithographically transferring a pattern from the reticle to the resist layer on the wafer. In step 717 (development) the exposed resist on the wafer is developed to form a usable mask pattern, corresponding to the resist pattern, in the resist on the wafer. In step 718 (etching), regions not covered by developed resist (i.e., exposed material surfaces) are etched away to a controlled depth. In step 719 (photoresist removal), residual developed resist is removed (“stripped”) from the wafer.

Formation of multiple interconnected layers of circuit patterns on the wafer is achieved by repeating the pre-processing and post-processing steps as required. Generally, a set of pre-processing and post-processing steps are conducted to form each layer.

It will be apparent to persons of ordinary skill in the relevant art that various modifications and variations can be made in the system configurations described above, in materials, and in construction without departing from the spirit and scope of this disclosure.

What is claimed is:

1. In a lithography system, an optical system, comprising:
at least a first optical-element set and a second optical-element set collectively configured to perform an optical function in which the at least first and second optical-element sets receive a light flux from a light source and direct the light flux for lithographic-imaging purposes, at least one of the optical-element sets being provided in the optical system as an ensemble of multiple counterpart optical-element sets that are individually selectable for positioning and use in performing the optical function; and
for each ensemble, a respective storage-and-exchange mechanism situated and configured to hold the ensemble and to move a selected optical-element set of the ensemble from an off-line position for placement at the operational position and to move another counterpart optical-element set of the ensemble from the operational position to an off-line position.

2. The system of claim 1, wherein the lithography system is an EUV lithography system.

3. The system of claim 2, wherein the optical system is an illumination-optical system in which each optical-element set comprises at least one respective EUV-reflective mirror.

4. The system of claim 3, wherein:
the first optical-element set comprises the ensemble; and
the second optical-element set is stationary.

5. The system of claim 4, wherein:
each counterpart optical-element set of the ensemble comprises a respective collimator-mirror set; and
the second optical-element set comprises a fly-eye-mirror set and a condenser-mirror set.

6. The system of claim 4, wherein:
each counterpart optical-element set of the ensemble comprises a collimator-mirror set and a fly-eye-mirror set; and
the second optical-element set comprises a condenser-mirror set.

7. The system of claim 3, wherein:
the first optical-element set comprises a first ensemble; and
the second optical-element set comprises a second ensemble.

8. The system of claim 7, wherein:
each counterpart optical-element set of the first ensemble comprises a respective collimator-mirror set; and
each counterpart optical-element set of the second ensemble comprises a respective fly-eye-mirror set and a respective condenser-mirror set.

9. The system of claim 3, further comprising a third optical-element set, wherein:
the first optical-element set comprises the ensemble; and
the second and third optical-element sets are stationary.

10. The system of claim 9, wherein:
each counterpart optical-element set of the ensemble comprises a respective collimator-mirror set;
the second optical-element set comprises a fly-eye-mirror set; and
the third optical-element set comprises a condenser-mirror set.

11. The system of claim 9, wherein:
each counterpart optical-element set of the ensemble comprises a respective fly-eye-mirror set;
the second optical-element set comprises a collimator-mirror set; and
the third optical-element set comprises a condenser-mirror set.

12. The system of claim 3, further comprising a third optical-element set, wherein:
the first optical-element set comprises a first ensemble;
the second optical-element set comprises a second ensemble; and
the third optical-element set is stationary.

13. The system of claim 12, wherein:
each counterpart optical-element set of the first ensemble comprises a respective collimator-mirror set;
each counterpart optical-element set of the second ensemble comprises a respective fly-eye-mirror set; and
the third optical-element set comprises a condenser-mirror set.

14. The system of claim 3, further comprising a third optical-element set, wherein:
the first optical-element set comprises a first ensemble;
the second optical-element set comprises a second ensemble; and
the third optical-element set comprises a third ensemble.

15. The system of claim 14, wherein:
each counterpart optical-element set of the first ensemble comprises a respective collimator-mirror set;
each counterpart optical-element set of the second ensemble comprises a respective fly-eye-mirror set; and
each counterpart optical-element set of the third ensemble comprises a respective condenser-mirror set.

16. In an EUV lithography system, an illumination-optical system, comprising:
at least a first mirror set and a second mirror set collectively configured to perform an optical function in which the first and second mirror sets receive an EUV light flux from an EUV source and direct the EUV light flux to a pattern master so as to illuminate a selected region of the pattern master, at least one of the first and second mirror sets being provided in the illumination-optical system as an ensemble of multiple counterpart mirror sets that are individually selectable for positioning and use at an operational position for performing the optical function; and
for each ensemble, a respective exchange mechanism situated and configured to hold the ensemble and to move a selected counterpart mirror set of the ensemble from an off-line position for placement at the operational position and to move another counterpart mirror set of the ensemble from the operational position to an off-line position.

17. The system of claim 16, wherein:
the first mirror set is located closer to the EUV source;
the second mirror set is located more distantly from the EUV source than the first mirror set; and
the ensemble is of multiple selectable counterpart mirror sets of the first mirror set.

18. The system of claim 16, wherein:
the exchange mechanism comprises a housing configured to hold the ensemble, the housing defining a respective branch for each of the selectable counterpart mirror sets of the ensemble; and
the exchange mechanism moves the respective branch of the selected counterpart mirror set into the operational position.

19. The system of claim. 18, wherein the branches of the housing are arranged as a turret that is rotatable about an axis by the exchange mechanism to place a selected branch of the turret in the operational position.

20. The system of claim 19, wherein the respective counterpart mirror set in each branch of the turret comprises a respective collimator mirror.

21. The system of claim 16, wherein:
the first mirror set comprises a mirror situated closest to the EUV source of all the mirrors of the illumination-optical system; and
the ensemble is of multiple selectable counterpart mirror sets of the first mirror set.

22. The system of claim 16, wherein:
the first mirror set is a collimator-mirror set;
the second mirror set comprises at least one fly-eye mirror and at least one condenser mirror; and
the ensemble is of multiple selectable counterpart mirror sets of the first mirror set.

23. The system of claim 16, wherein each counterpart mirror set in the ensemble consists of a single respective mirror.

24. The system of claim 23, wherein each single respective mirror in the ensemble is a respective collimator mirror.

25. The system of claim 23, wherein each single respective mirror in the ensemble has identical optical properties.

26. The system of claim 23, wherein at least two of the single respective mirrors in the ensemble have different optical properties.

27. The system of claim 16, wherein each counterpart mirror set in the ensemble consists of multiple respective mirrors including a respective collimator mirror.

28. The system of claim 16, wherein:
the first mirror set is provided in the illumination-optical system as a first ensemble of multiple selectable counterpart mirror sets that are individually selectable for positioning and use in performing the optical function; and
the second mirror set is provided in the illumination-optical system as a second ensemble of multiple selectable counterpart mirror sets that are individually selectable for positioning and use in performing the optical function.

29. The system of claim 28, wherein:
the first mirror set is contained in a respective housing that holds the multiple selectable counterpart mirror sets of the first mirror set in respective branches of the housing;
the multiple selectable counterpart mirror sets of the second mirror set are contained in individual respective housings;
the respective exchange mechanism for the first mirror set moves a selected branch to a respective operational position; and
the respective exchange mechanism for the second mirror set moves a selected counterpart mirror set in its respective housing to a respective operational position.

30. The system of claim 29, wherein the housing for the first mirror set does not contact the selected housing of the second mirror set.

31. The system of claim 29, further comprising:
a tracking interface situated between the respective operational position of the first mirror set and the respective operational position of the second mirror set; and
a respective actuator mechanism associated with at least one of the first and second mirror sets and configured to align the respective mirror set based on data, regarding positions of the selected counterpart mirror sets at their respective operational positions, produced by the tracking interface.

32. The system of claim 31, wherein the tracking interface produces the position data in the absence of physical contact of the first mirror set with the second mirror set.

33. The system of claim 32, wherein the tracking interface actively tracks the position of one of the first and second mirror sets relative to the position of the other of the first and second mirror sets.

34. The system of claim 29, wherein:
each of the counterpart mirror sets of the first mirror set comprises a respective collimator mirror; and
each of the counterpart mirror sets of the second mirror set comprises at least one mirror selected from the group consisting of fly-eye mirrors and condenser mirrors.

35. The system of claim 34, wherein each of the counterpart mirror sets of the second mirror set comprises a respective pair of fly-eye mirrors

36. The system of claim 35, wherein each of the counterpart mirror sets of the second mirror set further comprises a respective pair of condenser mirrors.

37. The system of claim 34, wherein:
each of the counterpart mirror sets in the first mirror set has identical optical properties; and
at least two of the counterpart mirror sets in the second mirror set have different optical properties.

38. The system of claim 34, wherein:
at least two of the counterpart mirror sets in the first mirror set have different optical properties; and
at least two of the counterpart mirror sets in the second mirror set have different optical properties.

39. The system of claim 34, wherein:
at least two of the counterpart mirror sets in the first mirror set have different optical properties; and
each of the counterpart mirror sets in the second mirror set has identical optical properties.

40. The system of claim 16, wherein:
each counterpart mirror set of the ensemble is housed in a respective housing; and
the exchange mechanism is operable to store the housings of off-line counterpart mirror sets and to move the housing of the selected counterpart mirror set into the operational position.

41. The system of claim 40, wherein:
the exchange mechanism comprises a rotary portion situated and configured to store the housings of off-line counterpart mirror sets; and
the exchange mechanism comprises a robot situated and configured to move the selected counterpart mirror set from the rotary portion to the operational position.

42. The system of claim 40, wherein:
the first mirror set is provided in the illumination-optical system as a first ensemble of multiple selectable counterpart mirror sets that are individually selectable for positioning and use in performing the optical function;
the second mirror set is provided in the illumination-optical system as a second ensemble of multiple selectable counterpart mirror sets that are individually selectable for positioning and use in performing the optical function; and
each counterpart mirror set of the first mirror set comprises a respective collimator mirror.

43. The system of claim 42, wherein each counterpart mirror set of the second mirror set comprises a respective pair of fly-eye mirrors.

44. The system of claim 43, wherein each counterpart mirror set of the second mirror set further comprises a respective pair of condenser mirrors.

45. The system of claim 16, further comprising a tracking interface situated between the first mirror set and the second mirror set, the tracking interface including a position-sensing device that detects position of the first and second mirror sets relative to each other.

46. The system of claim 45, further comprising at least one actuator system situated with at least one of the first and second mirror sets, the at least one actuator system being selectively actuatable to perform an adjustment of the position of at least one of the first and second mirror sets relative to each other, based on data from the position-sensing device, to align the first and second mirror sets.

47. The system of claim 46, wherein the actuator system comprises one or more actuators sufficient to move the respective mirror set in multiple degrees of freedom relative to the other mirror set.

48. In an EUV lithography system, an optical system, comprising:
first reflective-optical-element means and second reflective-optical-element means that are collectively configured to perform an optical function in which the first and second reflective-optical-element means receive EUV light from an EUV-source means and direct the EUV light for performing lithographic imaging;
at least one of the reflective-optical-element means comprising an ensemble of multiple selectable counterpart reflective-optical-element sets that are individually selectable for positioning and use in performing the optical function; and
exchange means, associated with each ensemble, for holding the ensemble, for moving a selected reflective-optical-element set of the ensemble from an off-line position for placement at the operational position, and for moving another counterpart reflective-optical-element set of the ensemble from the operational position to an off-line position.

49. The system of claim 48, wherein:
the optical system comprises illumination-system means for illuminating a pattern-master means; and
the optical function comprises illuminating selected portions of the pattern-master means with the EUV light.

50. The system of claim 49, wherein:
at least the first reflective-optical-element means comprises a respective ensemble and has an associated exchange means; and
the first reflective-optical-element means is situated proximally the EUV-source means and receives the EUV light from the EUV-source means.

51. The system of claim 50, wherein the first reflective-optical-element means comprises at least collimating means for receiving the EUV light from the EUV-source means and collimating the EUV light as the EUV light reflects from said collimating means.

52. The system of claim 48, wherein both the first and second reflective-optical-element means comprises a respective ensemble and an associated exchange means.

53. In a lithography system, a method for maintaining on-line operation of an optical system of the lithography system, the optical system comprising at least a first optical-element set and a second optical-element set that collectively perform an optical function in which the first and second optical-element sets receive a light flux from a light source and direct the light flux for a lithographic-imaging purpose, the method comprising:
configuring at least the first optical-element set as a respective ensemble of multiple counterpart optical-element sets that are individually selectable for positioning for use in performing the optical function;
selecting a desired counterpart optical-element set of the ensemble and placing the desired counterpart optical-element set at an operational position at which the selected counterpart optical-element set works cooperatively with the second optical-element set to perform the optical function.

54. The method of claim 53, wherein a currently selected counterpart optical-element set is moved into the operational position upon removing a previously selected counterpart optical-element set from the operational position.

55. The method of claim 54, wherein the currently selected and previously selected counterpart optical-element sets are moved using a storage-and-exchange robot.

56. The method of claim 53, wherein:
the first optical-element set is vulnerable to contamination during use; and
a currently selected counterpart optical-element set is moved into the operational position to replace a previously selected counterpart optical-element set that has become contaminated.

57. The method of claim 56, wherein:
the microlithography system is an EUV lithography system;
the optical system is situated downstream of an EUV source that produces particulate contamination; and
the first optical-element set is situated closer to the EUV source than the second optical-element set.

58. The method of claim 53, wherein:
the first optical-element set has a parameter that, when changed, correspondingly changes an operational aspect of the optical system; and
a currently selected counterpart optical-element set, having a first value of the parameter, is moved into the operational position to replace a previously selected counterpart optical-element set having a second value of the parameter, wherein the first value of the parameter is more desired than the second value in performing the optical function.

59. The method of claim 53, wherein:
the microlithography system is an EUV lithography system;
the optical system is an illumination-optical system; and
the first optical system comprises a collimator mirror.

60. The method of claim 53, wherein:
the microlithography system is an EUV lithography system;
the optical system is an illumination-optical system; and
the first optical system comprises at least one mirror selected from the group consisting of collimator mirrors, fly-eye mirrors, and condenser mirrors.

61. The method of claim 53, further comprising:
configuring the second optical-element set as a respective ensemble of multiple counterpart optical-element sets that are individually selectable for positioning for use in performing the optical function; and
selecting a desired counterpart optical-element set of the respective ensemble of the second optical-element set and placing the desired counterpart optical-element set at a respective operational position at which the selected counterpart optical-element set works cooperatively with the selected counterpart optical-element set of the first optical-element set to perform the optical function.

62. The method of claim 61, wherein:
the microlithography system is an EUV lithography system;
the optical system is an illumination-optical system situated downstream of an EUV source;
the first optical-element set is closer to the EUV source than the second optical-element set;
the first optical-element set comprises at least a collimator mirror; and
the second optical-element set comprises at least one mirror selected from the group consisting of fly-eye mirrors and condenser mirrors.

63. The method of claim 53, further comprising actively tracking the first and second optical-element sets relative to each other, without contacting each other, to maintain alignment of the first and second optical-element sets with each other for performing the optical function.
